(19) United States
(12) Patent Application Publication
(10) Pub. No.: US 2017/0154019 A1
(43) Pub. Date: Jun. 1, 2017

(54) TEMPLATE-DRIVEN TRANSFORMATION SYSTEMS AND METHODS

(71) Applicant: Open Text SA ULC, Halifax (CA)

(72) Inventors: Petr Filipský, Zelenec (CZ); Vladimir Lávicka, Jesenice - Zdimerice (CZ)

(21) Appl. No.: 15/365,626

(22) Filed: Nov. 30, 2016

Related U.S. Application Data
(60) Provisional application No. 62/261,138, filed on Nov. 30, 2015.

(51) Int. Cl. G06F 17/22; G06F 17/21; G06F 17/24

(52) U.S. Cl. CPC G06F 17/2264; G06F 17/248; G06F 17/218; G06F 17/2247; G06F 17/2241

(57) ABSTRACT

A computer-implemented method for use with a markup language structured document includes inputting a data template that represents an output data structure and a set of transformation rules corresponding to the nodes in the data template, and generating an output structured document based on the data template and the transformation rules. The method may perform transformation as process that includes compilation and execution. The compilation phase may include compiling transformation rules. The execution phase may comprise traversing the hierarchy in the transformation data template and evaluating each node in the hierarchy based on a corresponding transformation rule in the compiled transformation, the corresponding transformation rule including an instruction for populating the data structure with the source data in the data instance.

### RELATED APPLICATIONS

This application claims the benefit of priority under 35 U.S.C. §119 to U.S. Provisional Patent Application No. 62/261,138, filed Nov. 30, 2015, entitled “Template-Driven Transformation Systems and Methods”, the entire contents of which are hereby fully incorporated by reference herein for all purposes.

### TECHNICAL FIELD

This disclosure relates generally to the transformation and presentation of electronic documents. More particularly, embodiments relate to transformation of Extensible Markup Language (XML) documents and XML-like documents. More particularly, embodiments disclosed herein relate to systems, methods, and computer program products for template-driven transformation technology for transforming documents.

### BACKGROUND OF THE RELATED ART

XML is a text-based format that is one of the most widely-used formats for representing and sharing structured information on the World Wide Web (Web) today. Examples of structured information may include documents, data, configuration, books, transactions, invoices, images (SVG), etc. XML documents may be transformed into other XML documents, text documents, or Hypertext Markup Language (HTML) documents through various transformation technologies, including XQuery and Extensible Stylesheet Language Transformations (XSLT).

XQuery utilizes imperative programming and is result-oriented. Data enumeration is done explicitly. With XQuery a user typically has to call a function to open input XML stream in order to be able to traverse it. Moreover, structure of the generated output, individual imperative statements and source data selection strings are mixed together. Furthermore, with XQuery, transformation definitions are typically persisted as a set of text representing a program. It can be difficult to understand the expected structure of resulting XML data. For end users such as those using a document production system to produce documents (in a process that involves document transformation), it is not easy to grasp what the output may look like from reviewing XQuery code.

XSLT is a language recommended by the World Wide Web Consortium (W3C) for defining XML document transformation and presentation. Using XSLT, processors can operate on XML documents and anything that can be made to look like XML, for instance, relational database tables, geographical information systems, file systems, etc. XSLT utilizes XSLT stylesheets that contain XSLT “templates,” each of which contains a mixture of rules and format information. The templates are “source oriented” in that they are designed to match the pattern of source data.

Conventionally, an XSLT processor takes an XML input document and an XSLT style sheet, and processes them to produce an output document. The XSLT processor follows a fixed algorithm. The basic processing paradigm is pattern matching. Once an XSLT style sheet has been read and prepared, the XSLT processor builds a source tree from the input XML document. The XSLT processor then processes the source tree's root node, finds the best-matching template for that node in the XSLT style sheet, and evaluates the XSLT template's contents. A result is generated imperatively inside the templates. With XSLT, templates, pattern matching and commands for generating a result are all mixed to a single stylesheet. For end users, it is difficult to understand the expected structure of resulting XML data from a stylesheet.

XSLT is widely used. XSLT support is shipped with major computer operating systems and built in to major Web browsers to process multiple XML documents and to produce Web-ready documents. XSLT, however, does have some limitations, one of which is ingrained in the XSLT templates used by XSLT processors. As discussed above, XSLT stylesheets often contain a mixture of templates, pattern matching and commands for generating a result, making it difficult to understand what the output will look like. An issue may arise when processing large volumes of data. For example, large volumes of documents communicated from source systems to a data transformation system may contain a sizable amount of badly structured XML data. Due at least to the complexities present in XSLT templates and the source-oriented approach of XSLT templates, a sizable amount of badly structured XML data often needs to be fixed or otherwise repaired before these documents can be properly processed by XSLT processors. This, in turn, creates a need to construct a large number of scripts for processing the documents to identify and repair the badly structured XML data. Thus, particularly when large amounts of data are involved, an additional layer of processing may be needed prior to using XSLT technology.

### SUMMARY OF THE DISCLOSURE

According to one embodiment, a template driven transformation system can be provided. The template driven transformation system can comprise a data store storing a transformation data template comprising a hierarchy of nodes that represents an output data structure and independently storing a first transformation that comprises a set of rules for transforming input data into the output data structure specified by the transformation data template. In some embodiments, the hierarchy of nodes comprises a hierarchy of elements defined by markup language tags. Thus, according to one embodiment, the template may be defined using XML or an XML-like language. The rules may be defined independently from the template. The corresponding transformation rules can be defined in a key-value form using a declarative programming language. In some embodiments, the values can be defined by XPaths. Furthermore, transformation rules can be associated with corresponding data template elements by XPaths.

The system can further comprise a processor and a computer readable medium coupled to the processor storing a set of instructions executable by the processor to provide a data transformation engine. The transformation engine can be operable to receive an input set of transformation rules (a first transformation) and a data template and in a compilation phase, compile transformation rules from the first transformation into a compiled transformation, the transformation rules corresponding to elements in the transformation data template. Further, in an execution phase, the transformation engine can traverse the hierarchy in the transformation data template, evaluate each node in the hierarchy based on a corresponding transformation rule and populate the data structure with the source data in a data instance according to an instruction in the corresponding transformation rule to produce a document with data structured according to the output data structure.

The transformation engine is operable to traverse the data template. In one embodiment, the transformation engine looks up a corresponding rule for each template element and evaluates the rule's primary XPath expression. Such evaluation results in an empty or non-empty node set. For each such node the engine copies the template element to a resulting data instance and evaluates secondary XPath expressions for corresponding attributes and text nodes.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a diagrammatic representation of an example template-driven transformation (TDT) system according to some embodiments disclosed herein;

FIG. 2 shows an example data template and transformation;

FIG. 3 is a flow chart illustrating one embodiment of a method for document transformation;

FIG. 4 illustrates one embodiment of input data, a template, a transformation and a result;

FIG. 5A illustrates another embodiment of input data, a template and a transformation;

FIG. 5B illustrates one embodiment of a source transformation and a compiled transformation implementing a recurse;

FIG. 5C illustrates one embodiment of result based on the input data, template and transformations of FIG. 5A-5B;

FIG. 6A illustrates another embodiment of a template and a transformation;

FIG. 6B illustrates another embodiment of a compiled transformation;

FIG. 6C illustrates one embodiment of result based on the input data, template and transformations of FIG. 6A-6B;

FIG. 7 illustrates one embodiment of input data, a template, a transformation and a result for an example in which multiple nodes have the same name in the template;

FIG. 8 illustrates one embodiment of a template, a transformation and a result in which an external data source is referenced;

FIG. 9 illustrates one embodiment of a template, a transformation and a result for a tdt:split( ) function;

FIG. 10 illustrates one embodiment of input data, a template, a transformation and a result for a tdt:concat( ) function;

FIG. 11 illustrates one embodiment of input data, a template, a transformation and a result for a tdt:group( )and tdt:ungroup( ) functions;

FIG. 12 illustrates one embodiment of input data, a template, a transformation and a result for a tdt:group( )and tdt:nodeset( ) function;

FIG. 13 illustrates one embodiment of input data, a template, a transformation and a result for a tdt:template( ) function;

FIG. 14A illustrates another embodiment of input data and a template;

FIG. 14B illustrates an embodiment of a source transformation utilizing a union form;

FIG. 14C illustrates an embodiment of a compiled translation utilizing a union form;

FIG. 15A illustrates and embodiment of a template and a transformation utilizing an enumerate rule;

FIG. 15B illustrates and embodiment of a compiled transformation utilizing an enumerate rule;

FIG. 15C illustrates an example result from applying an enumerate meta-rule;

FIG. 16 illustrates and embodiment of a template, transformation and result for nested repetition;

FIG. 17 is a flow chart illustrating one embodiment of method for defining a template;

FIG. 18 is a flow chart illustrating one embodiment of method for defining transformation rules;

FIG. 19 illustrates one embodiment of a graphical user interface;

FIG. 20 illustrate one embodiment of a computing system.

FIG. 21 illustrates one embodiment of input data, a template, a transformation and a result for an example in which multiple nodes have the same name in the template.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Embodiments disclosed herein provide a new Template-Driven Transformation (TDT) technology with a new TDT language. The TDT technology is template-driven in a sense that it uses a template to specify a structure of the output markup document. The TDT data template may, for example, contain a data structure specifying an expected output of the source data that is, for instance, suitable for formatting and presentation on the Internet.

An aspect of the TDT technology relates to the separation of concerns: data templates and rules. A TDT data template, which specifies an expected output structure of content, is separate from TDT rules that provide the TDT data template with instructions on how transform input data into a data instance of the TDT template. This separation allows TDT data templates and TDT rules to be handled independently prior to transforming input data. A data consumer can easily define a structure of expected data in a TDT data template. Separately and independently, a data producer can specify TDT rules that may be applicable to the TDT data template. Moreover, the TDT rules themselves can be independently and separately defined. This way, two sibling template nodes can have corresponding TDT rules defined separately. On the other hand, in some embodiments, hierarchical rules may be used in which one or more rules are related to each other.

According to one embodiment, users of the TDT technology may, through a user-friendly graphical user interface (GUI), define/update a TDT data template or TDT rule in a declarative programming language (e.g., in a key-value form) referred to as the TDT language. An underlying transformation engine, referred to as a TDT engine, operates to perform the transformation.

The transformation engine can perform the transformation process in two main stages—compilation and execution—to realize the desired transformation specified by the TDT template and rules. In the compilation phase, the TDT engine uses a set of user defined rules and a TDT template to compile rules into a compiled transformation. This may entail copying user-defined rules from a source location to a destination location or transforming meta-rules to corresponding TDT rules on individual elements, which are then used by the TDT engine in the execution phase.

In the execution phase, the TDT engine implements the compiled transformation to produce transformed data. This may entail traversing a hierarchy (e.g., a tree) in the TDT data template and evaluating declarative expressions. In some embodiments, the declarative expressions may include XPaths and thus the transformation engine may comprise an XPath processor. The TDT engine may evaluate each node (e.g., element, attribute, text, etc.) in the hierarchy based on a corresponding TDT rule and may evaluate any variable declared in the corresponding TDT rule. The corresponding TDT rule may include an instruction for populating, in a data instance of the TDT data template, the data structure with the source data. Any custom XPath function discovered from the XPath evaluation can be registered with the TDT system so that it is reusable. In this way, a TDT engine can transform source data (e.g., an input document) to transformed data (e.g., a data instance of the TDT data template) based on applicable TDT rules.

In some embodiments, the TDT engine may, responsive to a change to the source data, the TDT data template, or the corresponding TDT rule, dynamically perform the transformation and present the transformed data reflective of the change via the user-friendly GUI. This way, a user can test a transformation and view the result immediately.

The TDT technology can be implemented as a powerful XML data transformation tool. One embodiment may be implemented as part of a document production system that uses the data instances produced by the TDT engine to generate .PDF documents, web pages, electronic mail, sms, meta records for device drivers or otherwise generates documents. Numerous other embodiments are also possible.

Embodiments disclosed herein can provide many advantages. For example, as discussed above, one person (e.g., a data consumer) can easily define an output format explicitly in the form of a TDT data template and, separately and independently, a completely different person (e.g., a data producer) can specify rules for filling in the actual dynamic data. Furthermore, multiple sets of rules can be specified for the same TDT template so that different forms of source data can be mapped to the same out output structure. Individual TDT rules can be independent as well, where sibling template nodes have corresponding rules defined separately. Therefore, a user can modify TDT rules for one template element without breaking rules for another element.

As another example, embodiments can leverage declarative programming, which is a non-imperative style of programming. This makes the TDT technology easier to understand than an imperative or procedural programming language. The TDT technology disclosed herein has other advantages over conventional imperative technologies, like X-Query as well. Such imperative technologies typically have mutable variables and user modifiable state, which complicates both implementation and maintenance. The overall space of possible machine state used by some embodiments of the TDT technology can be much smaller than conventional declarative style technologies. In some embodiments, the transformation engine can process transformations using only the internal state of the engine. In some embodiments, for example, all variables declared in a translation are immutable. Accordingly, in some embodiments, there are no mutable states that need to be created to track variables and thus the overall space of possible machine states used by the TDT technology can be much smaller than conventional declarative style technologies.

Moreover, since TDT can be declarative and well-structured, it can greatly simplify GUI Tool creation. XQuery, for example, uses text representing a program to define transformation, so it is relatively hard to present it in a form friendly for non-programmers. With embodiments described herein, on the other hand, the transformation definition is a set of rules where the individual rules can be a sequence of unified commands in key-value format, which lends itself to easily creating GUIs for non-programmers so that they can see the expected output structure hierarchy as a tree, use drag & drop and so on.

The TDT technology is also much more scalable and maintainable. New TDT rules can be readily defined and added. Existing TDT rules can be modified without breaking other TDT rules. Additionally, semantically related sources can be unified to a common syntax and reused. For example, a single TDT data template can be shared and used to perform different transformations. The TDT data template expresses the expected output data and different TDT rules may be applied to individual inputs.

Thus, there can be several (Y) data input variations that can all be mapped to a single data template structure using a data transformation for each variation. In this case, it is possible to maintain a single data template with Y sets of transformation rules. This approach may need less maintenance compared to Y*M separate XSLT or XQuery transformations.

As another benefit, in some embodiments, all tags in a TDT template can be user defined and there are no TDT specific tags necessary in the TDT template. Tags only have to follow the tag syntax supported by the transformation engine (e.g., XML). In some embodiments, some form of flag or marking can be used to indicate a dynamic data insertion point to a user. The transformation engine, in some embodiments, does not rely on the flag, but instead determines dynamicity of an entity based on a presence (or absence) of a corresponding transformation rule. Because, in such embodiments, the transformation engine does not rely on a flag in the template to identify dynamic entities (elements or attributes), a user can use any sample value (e.g., a character, such as “?”, a character string such as ‘dynamic’, ‘dog’ or other character string) and follow whatever convention he or she chooses (including none). For the convenience of the reader, a question mark is used throughout this specification to indicate a dynamic data insertion point in template.

In any event, because there are no specialized tags, the TDT engine can process XML-based formats like HTML, Scalable Vector Graphics (SVG) or others. Thus, existing HTML, XHTML or SVG can be used as a template. Moreover, users can use their specialized HTML, XHTML, SVG or other editor(s) to create and/or modify TDT data templates, since the TDT data templates do not contain TDT rules or TDT specific tags. Separately and independently, another user or users can create a set of TDT rules which define how input data will be transformed into the output structure specified by the template.

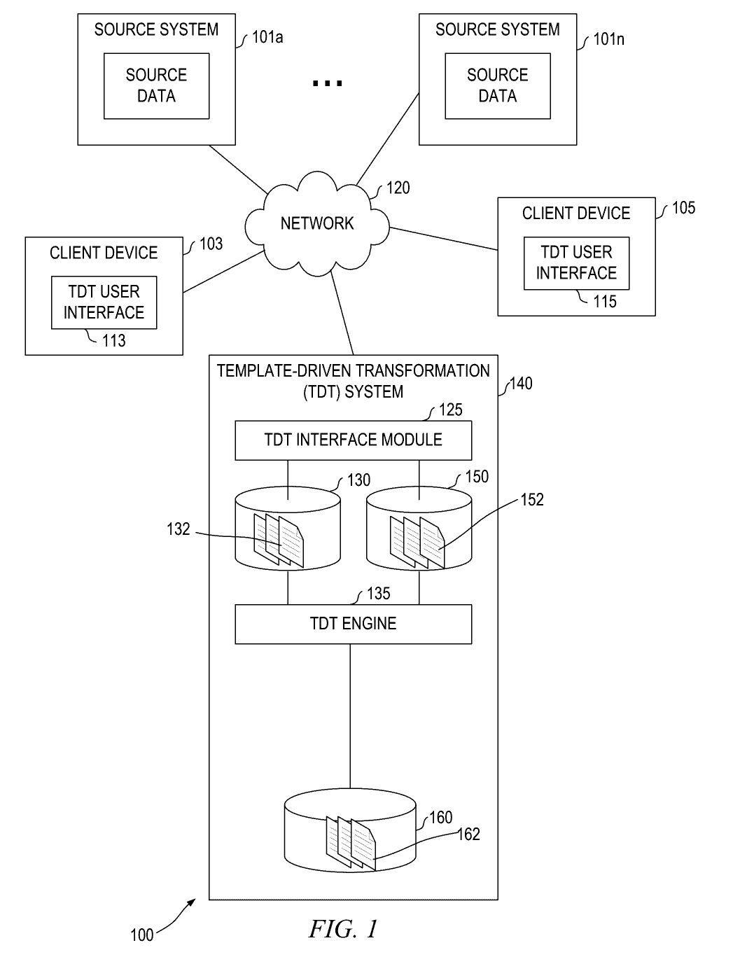

FIG. 1 depicts a diagrammatic representation of an example template-driven transformation (TDT) system according to some embodiments disclosed herein. In the example illustrated, TDT system 140 may operate in network computing environment 100 and may be communicatively connected to source systems 101a . . . 101n and client devices 103, 105, etc. over network 120. Skilled artisans appreciate that network 120 is representative of a single network or a combination of multiple networks. Network 120 may include a public network such as the Internet, a private network such as the intranet of an enterprise, or a combination thereof.

As explained below, users may interact with TDT system 140 (including transformation engine 135) via TDT user interfaces (e.g., TDT user interfaces 113, 115) provided by TDT interface module 125 of TDT system 140. TDT system 140 may further comprise data stores such as data store 130 for storing data templates 132, data store 150 for storing transformations 152 that contain TDT rules and data store 160 for storing data instances 162. Data stores 130, 150, 160, etc. may be embodied on a single non-transitory, physical data storage device or multiple data storage devices.

Source systems 101a . . . 101n may provide input data in XML and XML-like formats (referred to as “source data” in FIG. 1) to TDT system 140. In some embodiments, a source system may be a local database. In other embodiments, source systems may be remote sources. In accordance with one embodiment, input data may comprise message data structured according to a message model, such as described in U.S. Pat. No. 9,237,120, entitled “Message Broker System and Method,” filed Oct. 28, 2014 by Stefan Cohen, which is hereby incorporated by reference herein for all purposes. In some embodiments, data messages may be input as an XML stream or according to another format (for example, CSV). In some embodiments, TDT system 140 may perform transformation on message fragments as they are instantiated (e.g., as XML).

Transformation engine 135 can use a data template 132 and corresponding data transformation 152 to transform input data to create a data instance 162 (the product of the transformation process) having a structure that facilitates downstream processes. The template 132 can represent a desired data structure of a result data instance and the data transformation 152 can define operations to perform on input data to transform the input data into an output data instance 162 having the desired structure specified in a data template. The data instance 162 may be preserved (e.g., in data storage 160) or communicated to another system. In some embodiments, the data instance 162 can be serialized into an output data stream.

More particularly, input data may not have a structure consistent with a desired data presentation. A data template 132 can be defined to represent a presentation oriented data structure and a corresponding data transformation 152 can be created to transform the input data into a data instance 162 of the data template 132, the data instance having the desired data presentation structure represented in a corresponding data template 132. The data instance 162 can be passed to a document formatting process to format the data instance 162 into a document for presentation (e.g., as a web page, .pdf document, or other document). In some embodiments, transformation engine 135 can transform the input data (message or other data sources) to a dynamic runtime data instance 162 used in the document formatting process.

A data template 132 comprises a hierarchy of nodes (e.g., element nodes, text nodes, attribute nodes or comment nodes) defining a desired data structure. Data template nodes may be empty (no values defined), contain sample data or contain static values. A node specified in template 132 (a template node) can vary in occurrence in a resulting data instance 162. In accordance with one aspect of the present invention, however, the data template 132 represents structural information of data, i.e. the relation between parent, children and sibling nodes without including information about the occurrence of nodes.

Data templates 132 can fulfill several roles in a document design and formatting process. Data templates 132 can comprise hierarchies that represent expected presentation oriented data structures. During design, a user can prepare a data template 132 such that data instances 162 created based on that template are easily usable in presentation processes. In addition, a data template 132 may be utilized as a data interface through which presentation objects can accept data. For example, presentation objects can point to data template elements via XPath links or other mechanism. Furthermore, at run time, a data template 132 can define how a resulting data instance 162 will be structured and how much data will be present in an output stream, at least in the sense that a data template 132 may be used to restructure input data into a structure having fewer elements or attributes than the input data.

A data transformation 152 is a set of rules defined for a data template 132. The transformation rules provide instructions on how to transform input data (e.g., source data) into the structure defined by the data template 132. Transformation rules can be used for setting text and attribute values, repeated instantiation of data template nodes, fetching data from different sources, such as XML files, filtering and grouping data, and other operations. Multiple data transformations 152 may correspond to the same data template 132. For example, different transformations 152 may be defined for different data sources, input data structures, etc.

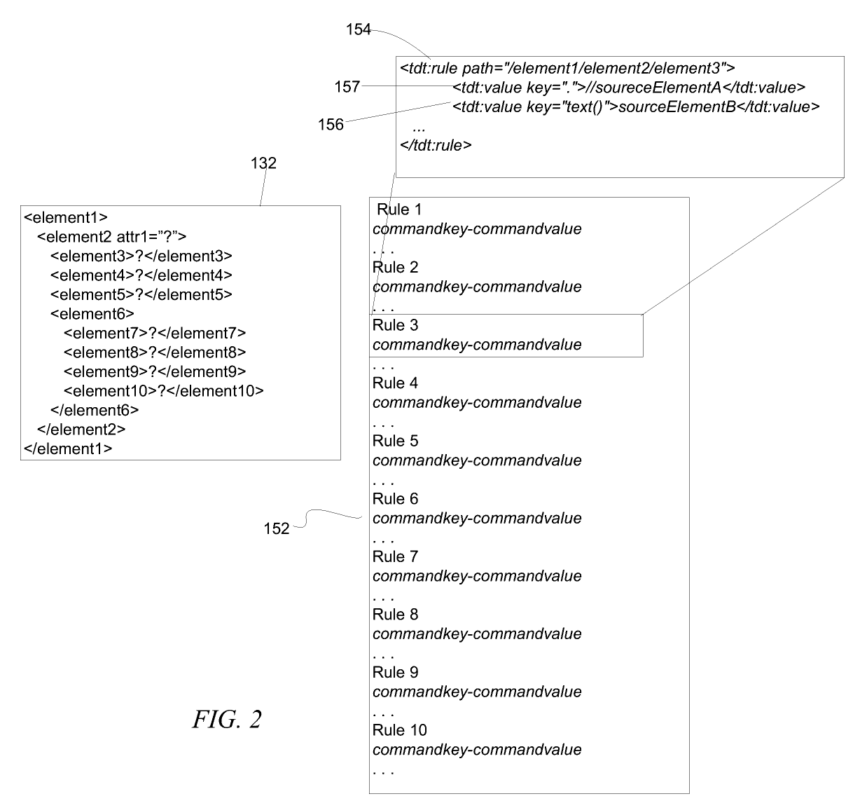

With reference to FIG. 2, one example of a data template 132 and a data transformation 152 are illustrated. In the example of FIG. 2, the template 132 uses XML to define a desired result structure. The data template comprises a hierarchy of nodes, including element nodes, text nodes, attribute nodes, comment nodes, etc. defining a desired structure. The boundaries of elements are either delimited by start-tags and end-tags, e.g., <element1></element1>, or, for empty elements, by an empty-element tag, e.g., <element1 />.

An element can contain one or more attribute name-value pairs that contain data related to a specific element. For example, in the following element: <person gender=“female”></person>, gender is an attribute of the <person>element. If an element contains an attribute, the template may provide a static or sample value for the attribute. On the other hand, the attribute may be dynamic, meaning that it is dependent on the rules in transformation 152. For example, the ? flag in template 152 indicates to users that attr1 of <element2>is dynamic. Again, however, in some embodiments, the question mark is just an indication for human users. The transformation engine can rely on the rules to identify dynamic attributes.

An element can contain other elements. The inclusion of elements in other elements defines a hierarchy/relationship of elements. In the example provided <element1> contains <element2>, <element2> contains <element3>, <element4>, <element5> and so on.

An element can also contain text content (text) between the start and end tags, e.g., in the following the <name>element contains the text “Sally” and the <age>element contains the text “12”.

<person gender=”female”>
<name>Sally</name>
<age>12</age>
</person>

An element in a template 132 may contain static or sample text, or the text can be dynamic (dependent on the rules in transformation 152). For example, the template 152 indicates to users that the text node of <element3> is dynamic.

According to the XML Document Object Model (DOM), everything in an XML document is a node. The document is a document node, every XML element is an element node, the text in the XML elements are text nodes, every attribute is an attribute node, comments are comment nodes (while not illustrated, an element may also include comments). In the example above, the <element2> element can be said to directly hold an attribute node but not a text node as the content of the <element2> is other elements not text content. <element3>, on the other hand, can be said to directly hold a dynamic text node. In some embodiments, the system prevents mixing text nodes and element nodes at the same level (e.g., an element will either directly hold text or another element, but not both).

The names of elements and attributes in template 132 may not have specialized meaning to the data transformation engine 135 in some embodiments. As such, the names of all elements and attributes in the template 132 can be user specified. This means, for example, that a user can use tags that may have special meanings in other languages, such as <p></p>that has the special meaning in HTML of defining a paragraph, without the tag having special meaning to data transformation engine 135. A user may therefore use an XML-like document (e.g., HTML, SVG, etc.) as a template and use his or her preferred HTML, SVG or other editor to edit the template. If template 132 contains tags that have specialized meaning in other languages, the result of the transformation executed by transformation engine 135 may include such tags, making the result directly usable as HTML, SVG or the like.

As exemplified by FIG. 2, some embodiments of data template 132 do not contain any transformation rules. Instead, the rules are defined separately (e.g., in a different XML document).

Transformation 152 specifies the rules for each data template node to include in the transformation process. The rules can be associated with a data template elements (e.g., Rule 1 is associated with <element1> and so on). In some instances, there may be no rule defined for an element.

A rule, according to one embodiment, comprises a series of declarative commands in key-value form (illustrated as commandkey-commandvalue). The command key can itself be an attribute having value (key value) that may have specialized meaning to transformation engine 135. In general, the commandkey has a value to specify what is being done with the results of processing the commandvalue. The commandkey can indicate, for the example, that the commandvalue should be processed to populate a text node or attribute value in an instance of the corresponding element of template 132, set a variable, return a set of nodes for evaluation, etc. The commandvalue can include static data to populate attributes and text nodes of the data template elements, a location in the data template, a location in the input data to find a value used to populate an attribute or text node, a function to apply for determining a value or node set or other commandvalue.

The commandkeys may have specialized meanings to transformation engine 135. For example, in some embodiments a command is used to specify the element to which a rule applies using a path. The following, for example, can indicate that the commandvalue specifies the element in template 132 to which a rule applies:
path:commandvalue

As another example, the commandkey can indicate that the commandvalue sets the nodes that are processed by the rule (e.g., the node set in the input data to which the rule applies).
.:commandvalue

If a TDT command is sets attribute values, the attribute(s) can be indicated with a special character, such as @, in the value of the key attribute For example, the following, if associated with <element 2> indicates that commandvalue is used to set the value of attr1 in an instance of <element 2>:
@attr1:commandvalue

If a TDT command sets a text node of a template element, this can be indicated with a predefined indicator in the key value. For example, the following, if associated with <element3>, indicates that the commandvalue is used to set the value the text node held by an instance of <element3>:
text( ) commandvalue

If a TDT command sets a variable, this can be indicated by including the variable as the value of the key. For example, using the above format and $ to designate a variable, the following indicates that the commandvalue is used to set the variable $hello:
$hello:commandvalue

Other values of commandkey may have special meaning to transformation engine 135. For example, the commandkey can be used to specify special types of rules or forms, examples of which are discussed below.

As would be appreciated by the skilled artisan from the foregoing, the syntax for the commandkeys can follow the XPath syntax. In other embodiments, a different syntax may be used. Other syntaxes may be used in other embodiments.

The commandvalues can include static values or can specify how transformation engine 35 should determine a value. The value returned by processing commandvalue may be a node set. In some embodiments, commandvalues are specified using XPaths that are processed by transformation engine 135. The XPaths can be arbitrarily complex and can include XPath functions, such as, but not limited to: boolean( ), ceiling( ) choose( ) concat( ), contains( ) count( ) current( ) document( ) element-available( ) false( ) floor( ) function-available( ) generate-id( ) id( ) key( ) lang( ) last( ) local-name( ) name( ) namespace-uri( ), normalize-space( ) not( ) number( ) position( ) round( ) starts-with( ) string( ) string-length( ) substring( ), substring-after( ), substring-before( ), sum( ) system-property( ) translate( ) true( )unparsed-entity-url( ) Examples of some custom XPath functions are discussed in more detail below. Furthermore, XPath expressions may incorporate XPath axes such as, for example: ancestor, ancestor-or-self, attribute, child, descendant, descendant-or-self, following, following-sibling, namespace, parent, preceding, preceding sibling, self or other XPath axes.

With respect to FIG. 2, Rule 3 includes commands 154, 156, 157. The commandkey “path” in rule 154 indicates that the command associates the rule with a template element and the commandvalue is an XPath pointing to <element3>thereby indicating that Rule 3 applies to <element3>. The commandkey in command 157-“.”-specifies the node set that is to be evaluated by the rule. The commandvalue is an XPath indicating that the evaluation context is the set of <sourceElementA>elements in the source data. The commandkey “text( )” in command 157 indicates that the commandvalue is used to set the text node in an instance of <element3>. The commandvalue is an XPath indicating that the value with which to fill the text node is the text node at a <sourceElementB> of <sourceElementA>. Other examples of commandkeys and commandvalues are discussed in embodiments below.

As can be understood from FIG. 2, in some embodiments, the rules may be persisted as a set of XML elements in the form:
<tdt:rule path=“XPath”>
   <tdt:value key=“commandkey”>commandvalue (static, variable or XPath)</tdt:value>
. . .
</tdt:rule>

In this example, each rule is represented by a <rule> element having a path attribute that indicates the element in data template 132 to which the rule applies. The <rule>element contains <value> elements, each including a key attribute, the values of which have specific meaning to transformation engine 135. The text nodes of the <value> elements contain static data, variable expressions, XPath expressions or constructs that have specialized meaning to data transformation engine. Rules can be persisted in other ways, using for example, a different XML structure or according to another language entirely.

Returning to FIG. 1, transformation engine 135 can implement data transformation to transform input data into a data instance 162 of the data template 132 in two phases: compilation and execution. In the compilation phase, transformation engine 135 takes a given source transformation 152 and data template 132 and produces a compiled transformation 155 (a runtime data instance of the transformation). To produce compiled transformation 155, transformation engine 135 determines if a rule is defined for each element in transformation 152. If a rule is defined for an element, transformation engine 135 can determine if the rule requires generating additional rules. If the rule does not require generating additional rules, the rule for the element can be copied from transformation 152 into the compiled transformation 155. In some cases, all rules in source transformation 152 can be copied to compiled translation 155 and compiled translation 155 can thus simply be a run time version of source transformation 152. However, some rules in a source transformation 152 may be meta-rules that require generating a set of corresponding rules. Two examples of meta-rules, “recurse” and “enumerate.” are provided below and transformation engine 135 can support other meta-rules. If a rule in source transformation 152 forms a meta-rule or otherwise requires generating additional rules, transformation engine 135 transforms the rule into the set of corresponding rules. This may include accessing the template 132 to determine elements for which additional rules should be generated. A compiled transformation 155 may thus include at least some different rules than source transformation 152.

The compiled transformation can be used by transformation engine 135 in the execution phase. In the execution phase, transformation engine 135 implements the translation based on data template tree traversal and rule evaluation (e.g., XPath evaluation), element, attribute, text data evaluation, variable declarations and function evaluation (e.g., XPath function evaluation). Transformation engine may evaluate each node (e.g., element, attribute, text, etc.) in the hierarchy based on a corresponding transformation rule and may evaluate any variable declared in the corresponding transformation rule. The corresponding transformation rule may include an instruction for populating, in a data instance of the data template, the data structure with the source data. Additionally, sorting functions may be performed.

According to one embodiment, transformation engine 135 can traverse a data template in “depth first, pre-order” (or according to other tree traversal schemes). After each element is evaluated, including its attributes and text nodes, transformation engine 135 continues sequentially to that element node's children. This process can continue in a depth first manner until all the elements have been processed. The transformation engine 135 may store the transformed data (e.g., a data instance of the data template 132) in a data storage device (e.g., data instance 162 of a data template in data store 160) and/or present the transformed data on a computing device (e.g., client device 103 shown in FIG. 1) communicatively connected to the TDT system over a network (e.g., network 120 shown in FIG. 1).

In some embodiments, transformation engine 135 may, responsive to a change to the source data, the data template, or the corresponding transformation rule, dynamically perform the transformation described above and present the transformed data reflective of the change via the user-friendly GUI. This way, a user can test a transformation and view the result immediately.

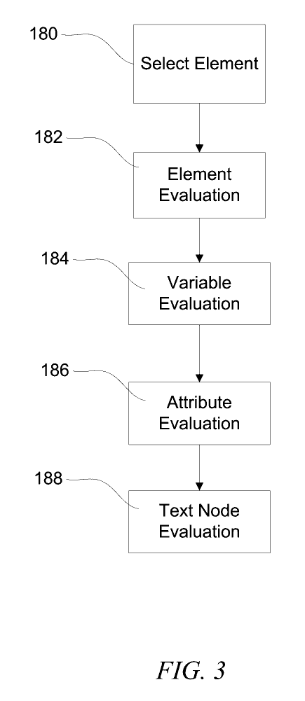

FIG. 3 is a flow chart illustrating one embodiment of executing a transformation that can be performed by a transformation engine 135. At step 180 an element can be selected from a data template for evaluation. As noted above, an element may be selected in a depth first manner, though other selection routines could be used. The transformation engine 135 can perform element evaluation (step 182), variable evaluation (step 184), attribute evaluation (step 186) and text node evaluation (step 188) for each element as needed.

At step 182, transformation engine 135 can perform an element evaluation. In element evaluation, the transformation engine 135 determines if there is a transformation rule for the element in the compiled transformation 155. In some embodiments, a full (absolute) path for the element can be used as a lookup key for a rule, e.g.:
<tdt:rule path=“/data/day/station”>. . .

In case several elements in the template share the same path, any XPath-based filtering method can be used. For example, an element can be selected based on attribute values, e.g.:
<tdt:rule path=“/data/day[©name=‘Friday’]/station[©genre=‘Rock’]”>...

As another example, index based paths can be used, for example, as follows:
<tdt:rule path=“/data/day[1]/station[3]”>

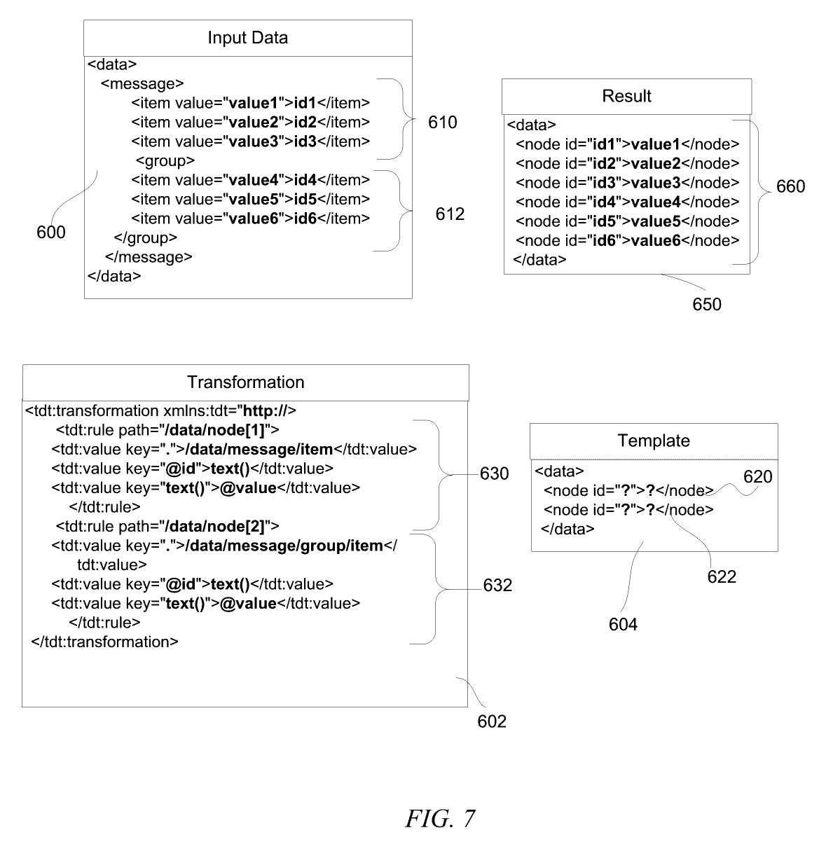

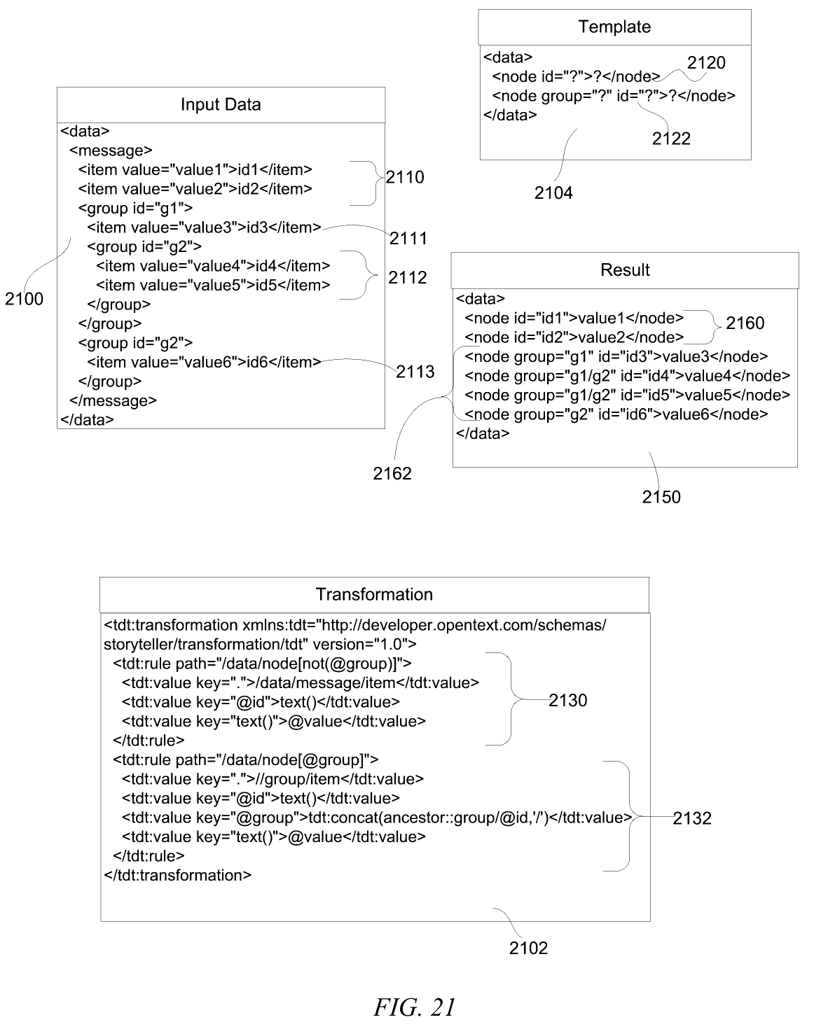

The use of filtering or index based paths to identify rules can be useful because, in some cases, it is desirable to have several elements in a data template with the same name. An example of this is disused in conjunction with FIGS. 7 and 21 below.

If no rule is found in the compiled transformation 155 for an element in the template, then the element can be left as is in data instance 162. On the other hand, if a rule is found, it is evaluated in the current evaluation scope. The element is then replaced in instance 162 by N (deep) copies where N is a size of an evaluation result node set. If the result node set is empty, then the element is removed from the data template instance 162 and none if its children are ever evaluated.

For example, if the evaluation result node set has two nodes, the selected template element can be replaced with two copies of the template element, one for each node in the evaluation result node set. Transformation engine 135 can maintain the data context for each copy of the template element so that the first copy is processed in the context of the first node in the evaluation result node set and the second copy is processed in the context of the second node in the evaluation result node set.

If a rule is found for an element at step 182 and the evaluation result node set is not empty, transformation engine 135 can perform one or more of variable evaluation (step 184), attribute evaluation (step 186) and text node evaluation (step 188). Variable evaluation, attribute evaluation and text node evaluation can include evaluating one or more variable evaluation, attribute evaluation or text (node) evaluation commands in the rule. The commands may include functions (e.g., XPath functions).

Turning to variable evaluation (step 184), a rule may declare one or more variables. According to one embodiment, each variable introduced in the current evaluation scope and its corresponding commandvalue (e.g., XPath expression) is evaluated. Variable evaluation can be performed after element evaluation so that variables do not have to be evaluated needlessly.

The following provides an example of rule containing variables.

```
<tdt:rule path=″/data/sentence″>
  <tdt:value key=″$hello″>′Hello′</tdt:value>
  <tdt:value key=″$world″>′World′</tdt:value>
  <tdt:value key=″$greeting″>concat($hello,’ ’,$world)</tdt:value>
  <tdt:value key=″text( )″>$greeting</tdt:value>
</tdt:rule>
```

Variables can be evaluated in declaration order. In this example, the variables are evaluated in this order: $hello—$world—$greeting. If the order in the example was changed to $greeting—$hello—$world then the $greeting variable would not be evaluated correctly because $hello and $world, on which the value of $greeting depends, would not have been previously declared.

According to one embodiment, variables are immutable. In such an embodiment, it is not possible to change a value of an already defined variable in the context of a particular transformation. In some embodiments, a variable may be valid and accessible in the scope of the whole data template subtree. In some embodiments, if a variable is declared in a rule associated with an element, but a variable of the same name was already declared in a superior scope (a scope of rule associated with a superior element), the variable can be shadowed by a new variable with the same name. Outside the scope of the nested variable, the superior variable is used.

For example, for the data template:

```
<data>
  <element1>?</element1>
  <element2>?</element2>
</data>
```

And the transformation:

```
<tdt:rule path=″/data″>
  <tdt:value key=″$test″>1</tdt:value>
</tdt:rule>
<tdt:rule path=″/data/element1″>
  <tdt:value key=″$test″>$test+1</tdt:value>
  <tdt:value key=″text( )″>$test</tdt:value>
</tdt:rule>
<tdt:rule path=″/data/element2″>
  <tdt:value key=″text( )″>$test</tdt:value>
</tdt:rule>
```

The expected result is:

```
<data>
  <element1>2</element1>
  <element2>1</element2>
</data>
```

In this example, the rule for the <data> element declared the variable $test, while a rule for the child <element1>declared ‘nested’ variable $test. The transformation engine hides the $test variable of the superior scope <data> when evaluating the subordinate <element1>. The value of 2 for $test is valid for the whole subtree starting at <element1>, but outside the scope <element1>the value 1 specified in the superior scope of the rule for <data> is in effect (e.g. for <element2>).

Transformation engine 135 can also perform attribute evaluation (step 186). According to one embodiment, transformation engine 135 can process XPath expressions in transformation rules to set attribute values for the elements in the template data instance. For example, transformation engine 135 can evaluate the following to set the value of attr1 in an instance of <element2 attr1=”?>.

<tdt:rule path=″/element1/element2 ″>
<tdt:value key=″@attr1″>commandvalue</tdt:value>
</tdt:rule>

Transformation engine 135 can also perform text node evaluation (step 188). According to one embodiment, transformation engine 135 can process XPath expressions in transformation rules to set text nodes in result elements. For example, transformation engine 135 can evaluate the following to set the value of the text node of <element3>:

<tdt:rule path=″/element1/element2/element3″>
<tdt:value key=″text( )″>commandvalue</tdt:value>
</tdt:rule>

Element evaluation, variable evaluation, attribute evaluation or text node evaluation may involve evaluating XPaths that are arbitrarily complex. In some cases, the XPaths may incorporate XPath functions. Therefore, transformation engine 135 can include an XPath processor and support a variety of XPath functions.

The steps of FIG. 3 can be repeated until all the elements in the source template 132 have been evaluated (or eliminated from evaluation) to populate a data instance 162 of the template 132.

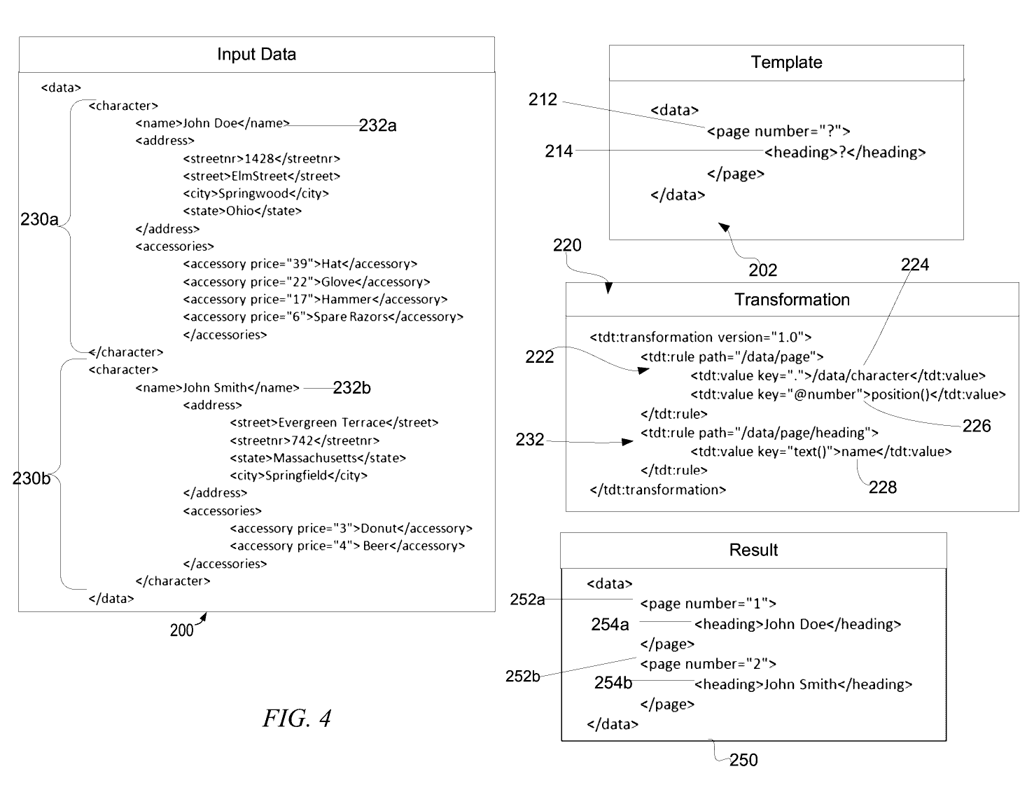

Transformation system 140 can be a flexible system providing a variety of transformations. FIGS. 4-16 provide some non-limiting examples of input data, templates 132, transformations 152, compiled transformations 155 and resulting data instances 162. In some of these examples, there may be no difference between the rules in a source transformation and a compiled transformation. In such examples, the provided transformation can represent an example of a transformation 152 and a compiled transformation 155

To provide some additional context, FIG. 4 illustrates one embodiment of a set of input data 200, a data template 202, which can be an example of a data template 132, a transformation 220, which can be an example of a transformation 152 or compiled transformation 155. FIG. 4 also illustrates an example transformation result 250, which may be the resulting data instance of template 202. In the embodiment of FIG. 4, input data 200 includes a list of movie characters and accessories associated with the characters. In this example, however, a user wishes to present each character on its own page with each page containing a dynamic heading customizable by the character's name. Furthermore, the user does not require much of the data in input data 200 for presentation.

Template 202 can be defined to represent the desired result structure. Data template 202, in the illustrated embodiment, represents a presentation oriented data structure that better suits the user's presentation needs than the input data structure. Data template 202 defines a hierarchy of nodes including a <data> element, a <page> element 212 and a <heading> element 214. In this example, <data> is the root node. The <page> element holds the “number” attribute and <heading> element. <heading> element 214 holds a text node. The “?” in the number attribute of <page> element 212 indicates that the attribute is dynamic and the “?” in the text node of <heading> element 214 indicates that the text node is dynamic. These nodes are dynamic in the sense that the values of instances of the nodes depend on the transformation rules applied.

Transformation 220 includes two rules, rule 222 and rule 232. The “path” attribute of rule 222 is set to “/data/page” indicating that rule 222 corresponds to <page> element 212 and the path for rule 232 is set to “/data/page/heading” indicating that rule 232 corresponds to <heading> element node 214. In rule 222, command 224 (<tdt:value key =“.”>/data/character</tdt:value>) sets the evaluation context for XPath expressions in rule 222. In this case, the evaluation context includes a node set of all nodes with the path data/character in the input data 200. Command 226 specifies that the values of the attribute “number” in instances of <page> element 212 are to be determined using the XPath “position( )” function in the current evaluation context (the context set in command 224). It can be noted that the page number attribute value is not present in the source data and is fully synthesized—that is, generated dynamically by calling the ‘position( )’ XPath function. Command 228 specifies that the text nodes in instances of the <heading> element 214 are to be set by the text node of the corresponding the <name> element in the current evaluation context (e.g., at data/character/name).

During compilation, transformation engine 135 can evaluate transformation 220 to determine if any of the rules require generating additional rules. Because the rules in transformation 220 do not, the rules can be copied to the compiled data transformation. Since the rules in the compiled transformation will be identical to the rules in transformation 220 in this example, the compiled transformation is not discussed separately.

In the execution phase, transformation engine 135 can first evaluate the <data> element and determine that there is no rule defined for the <data> element in transformation 220. Transformation engine 135 can therefor leave the <data> element as is, as shown in resulting data instance 250. When transformation engine 135 reaches <page> element 212, it can search transformation 220 and find rule 222. Transformation engine 135 can then process node evaluation command 224 to locate all the data/character elements specified by the XPath in command 224 and create the evaluation result node set. In this case, the evaluation result node set includes “/data/character” elements 230a and 230b from input data 200. Since there two input nodes to which the template <page> element applies, transformation engine 135 can create two <page> elements 252a, 252b in the data instance, with the first instance corresponding to source <character> element 230a and the second instance corresponding to source <character> element 230b. Transformation engine 135 can then process each copy of <page> element 214, maintaining the data context for each copy such that the first copy is populated based on <character> element 230a and the second copy is populated based on <character> element 230b. Transformation engine 135 can further maintain this context hierarchically so that attributes and text nodes in the subtree of the first copy are evaluated with respect <character> element 230a and the attributes and text nodes in the subtree of the second copy are evaluated with respect to <character> element 230b.

During attribute evaluation of each copy of <page> element 212, transformation engine 135 will evaluate command 226. In this case, the attribute evaluation will include evaluating the XPath position( ) function, the functionality of which is known in the art. Because the first copy of <page> element 212 corresponds to <character> element 230a, and <character> element 230a is the first node in the evaluation node set, the “number” attribute in the first copy of <page>element 212 will be assigned the value “1” by the XPath position( ) function, whereas because <character> element 230b is the second node in the evaluation result node set, the “number” attribute in the second copy of <page> element 212 will be assigned the value “2” as illustrated by <page> elements 252a, 252b.

The text node in each heading element 254 is set based on rule 232. According to this rule, the text in a <heading> element will be a copy of the text node held by a corresponding <name> element 232a, 232b in input data 200. The text node of the first copy of the <heading> element will be assigned the value of <name> element 232a's text node and the second copy of the <heading> element will be assigned the value of <name> element 232b's text node as shown by <heading> elements 254a, 254b.

In the example of FIG. 4, the source transformation rules can be used in the compiled transformation. However, in other cases, the compiled transformation may include additional or alternative rules. For example, when a recurse is contained in a rule referencing a base path, the transformation engine 135 can automatically generate corresponding rules for the whole subtree of that base path.

One example of a recurse rule is illustrated below:

```
<tdt:rule path=″/data/employee″>
  <tdt:value key=″.″>/data/message/employee</tdt:value>
  <tdt:value key=″recurse″>.</tdt:value>
</tdt:rule>
```

In this example, the transformation engine will automatically generate rules for each element descended from the current template context <employee>. In processing a recurse, transformation engine 135 can generate one or more of a command to associate a rule with template element, an element evaluation command to set the evaluation scope for the rule, an attribute evaluation command if the element holds a dynamic attribute or a text node evaluation command if the element holds a dynamic text node.

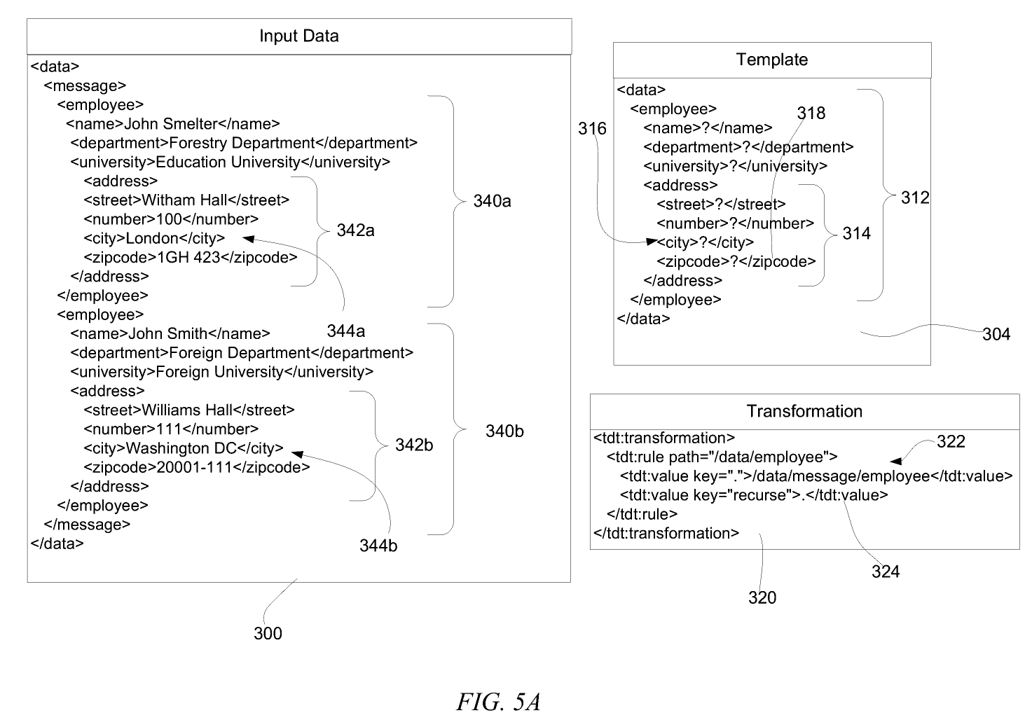

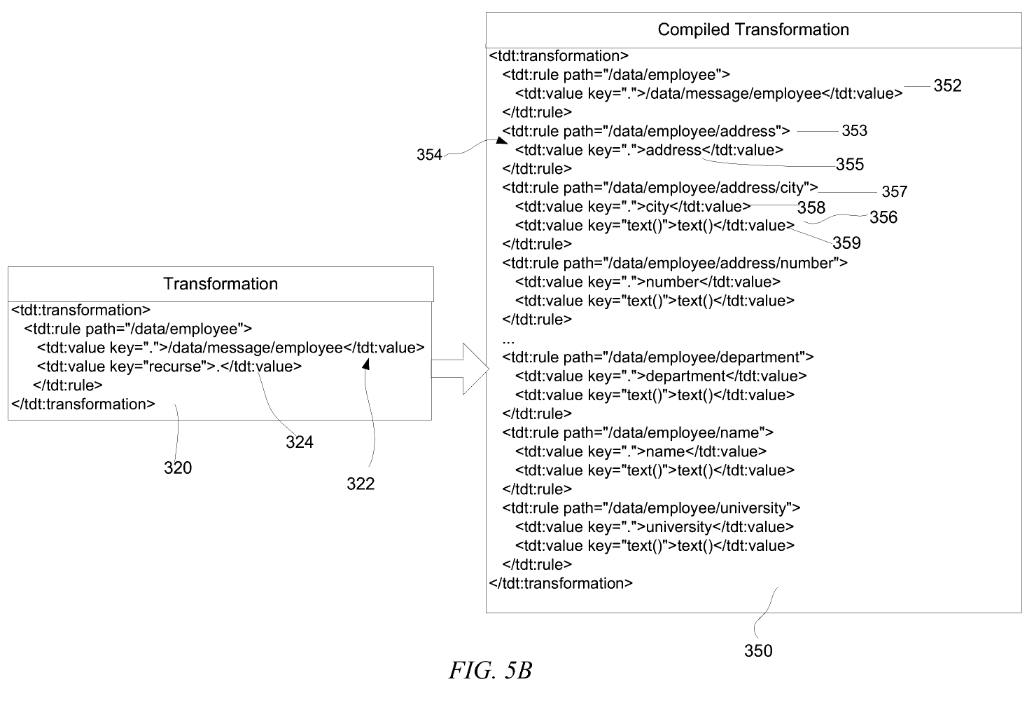

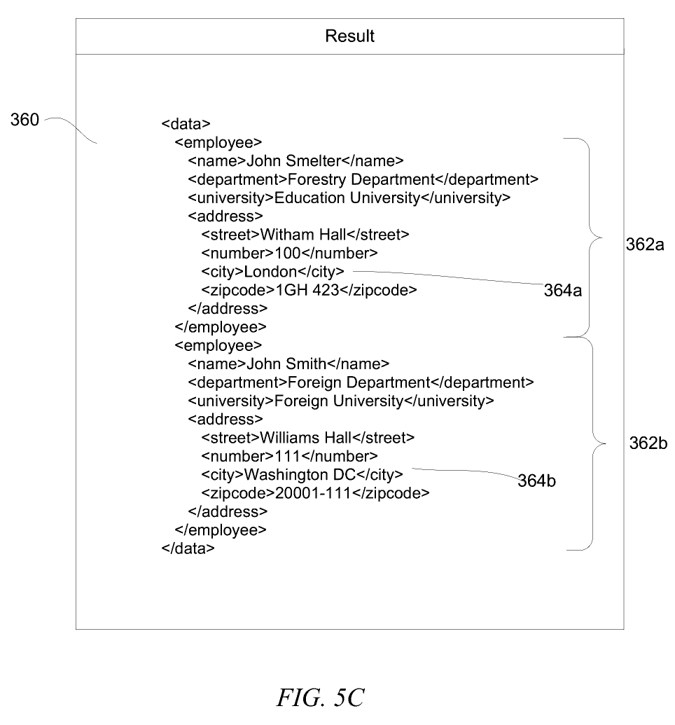

An example of utilizing this recurse rule is illustrated in FIG. 5A, FIG. 5B and FIG. 5C (collectively FIG. 5). FIG. 5 illustrates a set of input data 300, a data template 304, a source data transformation 320 having a recurse rule 322, a compiled data transformation 350 and a transformation result 360, which can be a data instance of data template 304. In this example, the input data 300 contains a <message> element containing a structure of elements holding employee data. In this example, data template 304 is configured so that result 360 will only contain the employee data copied from the input data without any changes.

During the compilation phase, transformation engine 135 can access data template 304 and data transformation 320, checking whether any rules have been defined in data transformation 320 that require generating additional or alternative rules. If a rule does not require generating additional rules, the rule can be copied into complied data transformation 350. In this example, however, data transformation engine 135 will reach rule 322 containing a recurse command 324 and will generate new rules.

In processing the recurse expression 324, transformation engine 135 can select a child element of <employee> 312 based on selection rules. For example, transformation engine 135 may respect the order of elements in data template 304. Other selection rules may also be used (e.g., alphabetical order). Accordingly, transformation engine 135 can select the <address>element 314. Transformation engine 135 can generate a transformation rule 354 for <address>element 314. In the embodiment illustrated, transformation engine 135 generates rule 354 with command 353 having an XPath to associate the rule with <address> element 314 and element evaluation command 355 to set the evaluation scope for the rule. In this example, transformation engine 135 assumes the structure of the relevant subtree in template 304 and input data 300 are the same and simply uses the name of the current data template node (i.e., <address>) in setting a relative path in command 355 for the evaluation context. Because <address> element 314 does not directly hold a corresponding attribute or text node, transformation engine 135 can move down to the next level in the subtree and create a rule for the <street> element, <number> element, <city> element 316 and <zipcode> element in turn.

Using the example of <city> element 316, transformation engine 135 can generate a rule 356 with a command 357 that associates the rule with <city> element 316 and an element evaluation command 358 to set a relative path for the evaluation context for the rule. Moreover, because the <city> element 316 does directly hold a dynamic text node (as indicated by “?”), transformation engine 135 can generate a text node evaluation command for setting the value of the text node during execution. For example, transformation engine 135 can generate command 359 of rule 356. If <city> element 316 included a dynamic attribute, say @population (e.g., <city population=“?”>), transformation engine 135 could similarly generate an expression for the parameter, such as:
<tdt:value key=“@population”>@population</tdt:value>

In any event, because <city> element 316 is a leaf node, transformation engine 135 can return to the next level up and process the next element, in this example <zipcode> element 318. This process can continue as transformation engine 135 generates compiled data transformation 350. In some embodiments, the rules are sorted (e.g., in alphabetical order by element) to speed up rule lookup times.

The execution phase can proceed as discussed above, with transformation engine 135 traversing the node tree and performing element evaluation, variable evaluation, attribute evaluation and text evaluation on each element as needed. According to rule 352, two copies of template <employee> element 312 will be create in the template data instance because there are two /data/message/employee nodes in input data 300, <employee> element 340a and <employee> element 340b. Thus, result 360 includes <employee> element 362a and <employee> element 362b. <employee> element 362a includes <city> element 364a with a text node copied from input data <city> element 344a and <employee> element 362b includes <city> element 364b having a text node copied from input data <city> element 344b.

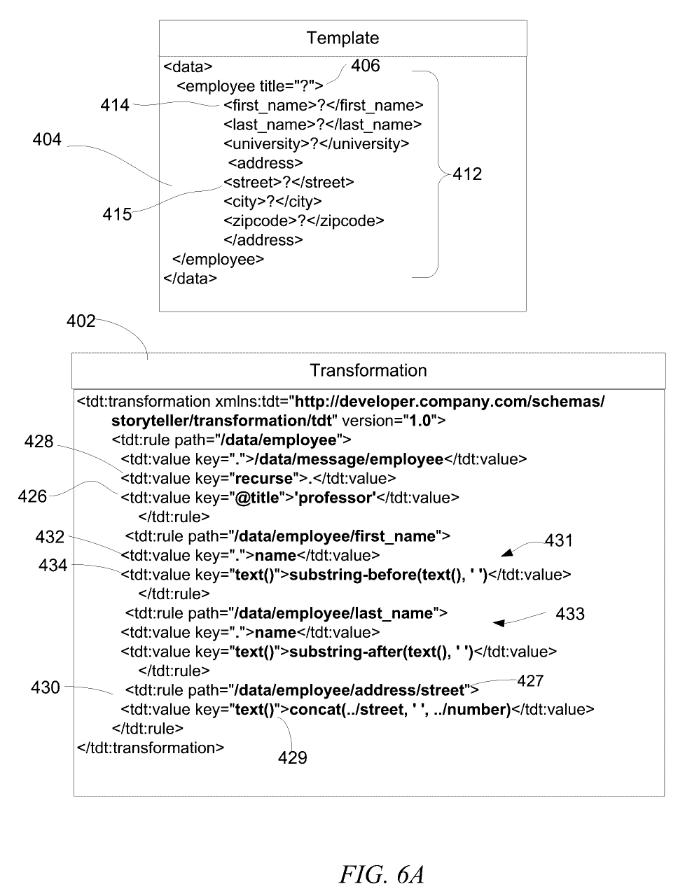

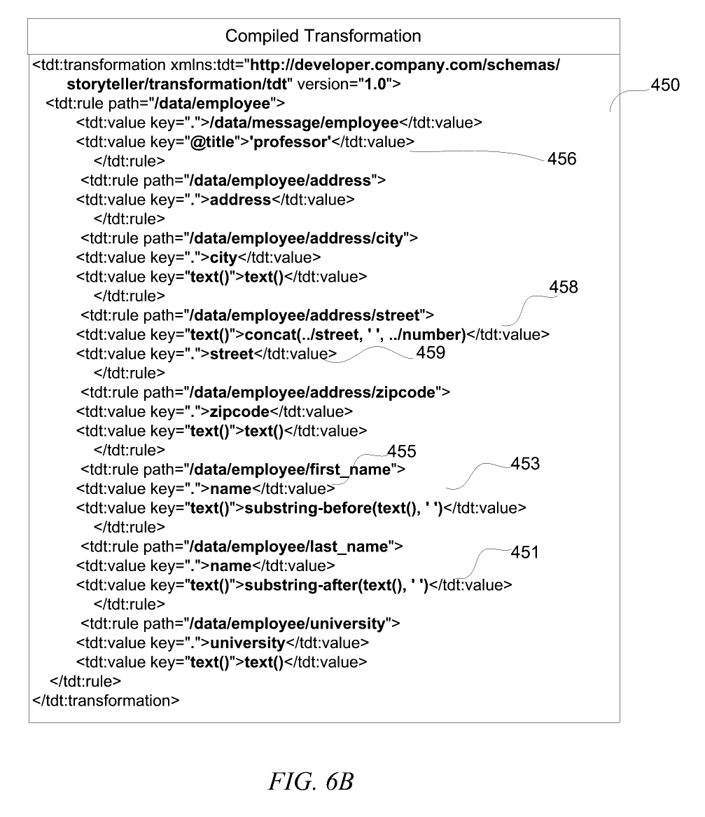

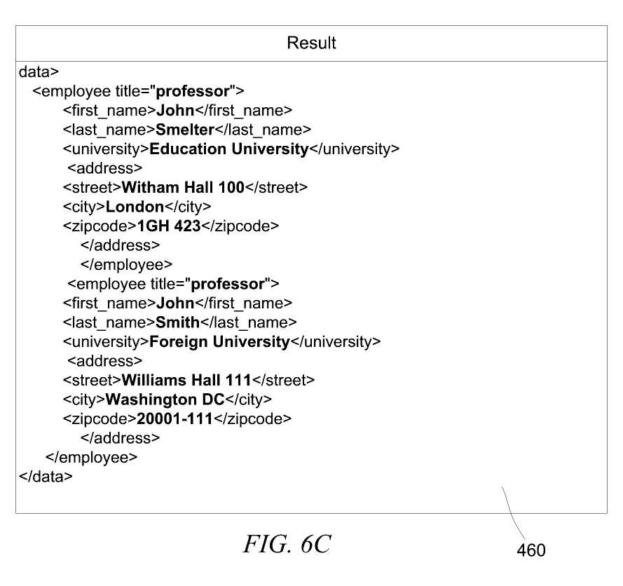

FIG. 6A, FIG. 6B and FIG. 6C (collectively FIG. 6) illustrate another embodiment of a data template 404 and data transformation 402 for transforming input data 300 of FIG. 5 to achieve a result 560. In contrast to FIG. 5, the embodiment of FIG. 6 augments the employee data. First, template 404 introduces a “title” parameter (indicated at 406) to the <employee> element node. This parameter is set by rule 426 in source transformation 402 and is copied to compiled transformation 450 as rule 456 (FIG. 6B). As such, the attribute “title” has a value of ‘professor’ in <employee> elements 466 of result 460 (FIG. 6C). Second, rule 458 of transformation 402 concatenates the <street>and <number> elements. Last, but not least, rules 451, 453 split the <name> value into <first_name> and <last_name> values.

Data transformation 402 includes a recurse expression 428. Because the recurse is set for <employee> element 412 of data template 404, the transformation engine 135 can process the subtree below <employee> element 428 as described above. In this example when transformation engine 135 reaches <first_name> element 414 at /data/employee/first_name in template 404, it will find that transformation 402 includes a rule 431 for <first_name> element 414 including a command 432 associating rule 431 with <first_name> element 414 and a text evaluation command 434. Because transformation 402 already includes a command 432 to associate the rule with <first_name> element 414 and text evaluation command 434, transformation engine 135 will not generate new versions of these commands but can simply copy them to compiled transformation 450. Moreover, because <first_name> element 414 does not directly hold an attribute, transformation engine 135 does not generate an attribute evaluation command. However, because there is no element evaluation command in rule 431, transformation engine 135 can generate element evaluation command 455. The rule 451 for the <last_name> element 415 can be compiled similarly as discussed in conjunction with <first_name> element 414.

As another example, when transformation engine 135 reaches <street> element 415 at /data/employee/street in template 404, it will find that transformation 402 includes a rule 430 for <street> element 414 including a command 427 associating rule 430 with <street> element 414 and a text evaluation command 429. Because transformation 402 already includes command 427 to associate the rule with <street> element 414 and text evaluation command 429, transformation engine 135 will not generate new versions of these commands but can simply copy them to compiled transformation 450. Moreover, because <street> element 414 does not directly hold an attribute, transformation engine 135 does not generate an attribute evaluation command. However, because there is no element evaluation command in rule 430, transformation engine 135 can generate element evaluation command 459. The compiled transformation 450 can be processed in the execution phase to generate result data instance 460 (FIG. 6C).

In the foregoing examples, each element in the template had a unique name. However, in some cases, two elements may have the same name. FIG. 7 illustrates an example in which a data template 604 has multiple data template elements with the same name. In the embodiment of FIG. 7, <item> elements 612 in input data 600 are contained in the <group> element, whereas <item> elements 610 are not. In this example, the user wishes the result 650 to contain data from <item> elements 612 and <item> elements 610 in elements with the same name (e.g., <node>). This can provide a consistent element name through which downstream processes can access the data.

In the illustrated embodiment, template 604 has a first <node> element 620 and a second <node> element 622 having the same name. In transformation 602, rule 630 is associated with first <node> element 620 using the indexed path “/data/node[1]” and rule 632 is associated with second <node> element 622 using the indexed path “/data/node[2]”.

During element evaluation, <node> element 620 can be selected and rule 630 identified. Because the evaluation scope of rule 630 is all <item> elements at /data/message/item (based on <tdt:value key=“.”>/data/message/item</tdt:value> in rule 630) and there are three such <item> elements 610, the evaluation result node set has three nodes. As such <node> element 620 can be replaced by three copies in the data instance of template 604. For each copy of <node> element 620, transformation engine 135 can perform attribute evaluation and text node evaluation.

<node> element 622 can then be selected and rule 632 identified. Because the evaluation scope of rule 630 is all <item> elements at /data/message/group/item (based on <tdt:value key=“.”>/data/message/group/item</tdt:value>in rule 632) and there are three such <item> elements 612, the evaluation result node set has three nodes. As such <node> element 622 can be replaced by three copies in the data instance of template 604. For each copy of <node> element 622, transformation engine 135 can perform attribute evaluation and text node evaluation. As shown in result 650, data from <item> elements 610 and <item> elements 612 can be contained in <node> elements 660, all having the same name.

The embodiment of FIG. 21 illustrates another example in which several elements in template 2104 have the same name. In this embodiment, transformation engine 135 selects rules based on attribute filtering (the presence or absence of one or more attributes).

<item> elements 2111 in input data 2100 are contained in the <group> element having id=“g1”, <item> elements 2112 are contained in the <group> element having id=“g2” that is a child of the <group> element having id=“g1” and <item> element 2113 is contained in the <group> element having id=“g2” that is a child of the <message> element, whereas <item> elements 2110 are not contained in any <group> element. In this example, the user wishes the result 2150 to contain data from <item> elements 2110, 2111, 2112 and <item>in elements with the same name (e.g., <node>).

In the illustrated embodiment, template 2104 has a first <node> element 2120 and a second <node> element 2122. In transformation 2102, rule 2130 is associated with first <node> element 2120 using “/data/node[not(©group)]” and rule 2132 is associated with second <node>element 2122 using “/data/node[©group]”.

During element evaluation, <node> element 2120 can be selected and rule 2130 identified. Because the evaluation scope of rule 2130 is all <item> elements at /data/message/item (based on <tdt:value key=“.”>/data/message/item</tdt:value>in rule 2130) and there are two such <item> elements 2110, the evaluation result node set has two nodes. As such <node> element 2120 can be replaced by two copies in the data instance of template 2104. For each copy of <node> element 2120, transformation engine 135 can perform attribute evaluation and text node evaluation. As shown in result 2150, data from <item> elements 2110 can be contained in <node> elements 2160.

<node> element 2122 can then be selected and rule 2132 identified. Because the evaluation scope of rule 2130 is all <item> elements at //group/item and there are four such <item>elements (one <item> element 2111, two <item> elements 2112, and one <item> element 2113), the evaluation result node set has four nodes. As such <node> element 2122 can be replaced by four copies in the data instance of template 2104.

Rule 2132 contains the tdt:value for the @group attribute with the XPath expression: tdtconcat(ancestor.:group/@id,‘/’). This XPath expression uses the XPath ancestor axis that returns a nodeset of all ancestors of the current node. In this example, rule 2132 can retrieve a value of @id attribute for each group node ancestor and concatenate all the values into a single string using ‘/’ as a separator. For each copy of <node> element 2122, transformation engine 135 can perform attribute evaluation and text node evaluation. The resulting string represents a unique identifier of the corresponding group hierarchy: “g1”, “g1/g2”, “g2”. As shown in result 2150, data from <item> elements 2111, 2112 and 2113 can be contained in <node> elements 2162.

As discussed above, commandvalue XPath expressions may incorporate XPath functions. Transformation engine 135 can support XPath functions specified or recommended by World Wde Web Consortium (W3C). In some cases, transformation engine 135 may support custom XPath functions. In the execution phase, all available custom XPath functions (e.g., tdt:concat( ), tdt:group( ), . . . ) can be registered to the underlying XPath context before the evaluation steps occur. Several example functions are discussed in more detail below.

tdt:document(<string>) provides access to an external XML source document. According to one embodiment, the string may include a URL to an XML or XML-like document. URL schemes may include, for example file:, ftp:, http: or other URL schemes. In some embodiments, the tdt:document( ) function can provide access to network accessible repositories.

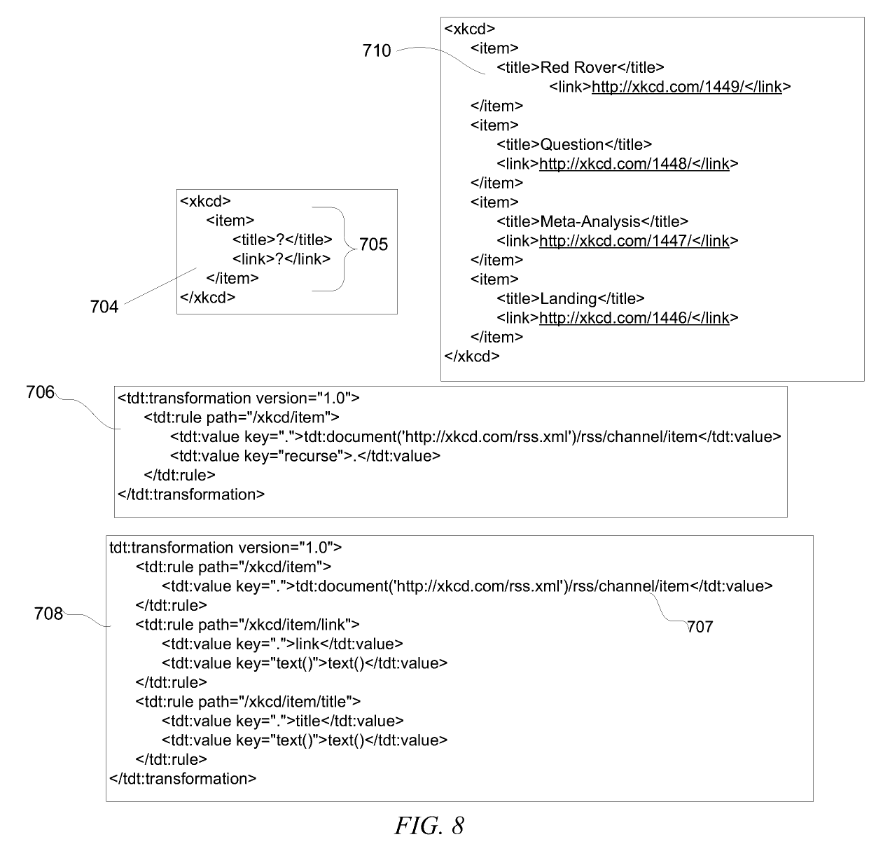

FIG. 8 provides an example of utilizing the document( ) function to reference an external data source. FIG. 8 depicts a template 704, source transformation 706, compiled transformation 708 and result 710. Using the document( ) function, command 707 in compiled transformation 708 sets the result evaluation scope for the rule to be the set of <item> elements in the document http://xkcd.com/rss.xml having the XPath /rss/channel/item. In this example, there were three such <item> elements and <item> element 705 was copied three times in the resulting data template instance.

A tdt:tokenize function can split up strings and return a node-set of token elements, each containing one token from the string. The first argument is one or more strings to be tokenized. The second argument is a string consisting of a number of characters. Each character in this string is taken as a delimiting character. The strings given by the first argument are split at any occurrence of any of these characters. For example, for the template:

<data>
<token>?</token>
</data>

The following rule:

```
<tdt:rule path=″/data/token″>
  <tdt:value key=″.″>tdt:tokenize( ’2001-06-03T11:40:23’, ’-T:’ )</tdt:value>
  <tdt:value key=″text( )″>text( )</tdt:value>
</tdt:rule>
```

can result in:

```
<data>
  <token>2001</token>
  <token>06</token>
  <token>03</token>
  <token>11</token>
  <token>40</token>
  <token>23</token>
</data>
```

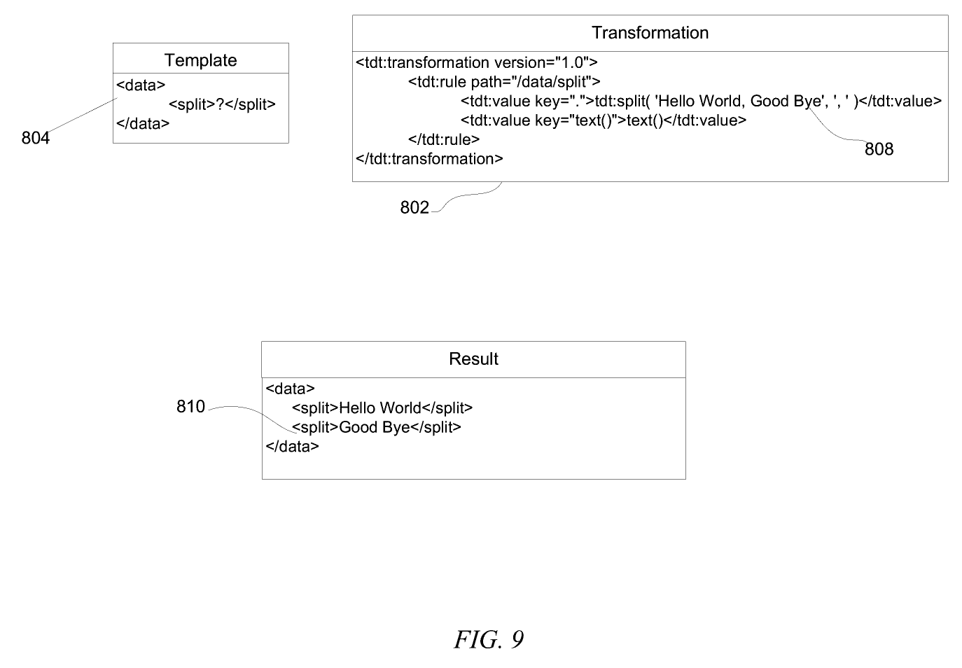

The tdt:split( ) function splits up given strings and returns a node set of token elements, each containing one token from the string. The first argument is one or more strings to be split. The second argument is a pattern string. FIG. 9 illustrates one embodiment of the operation of the tdt:split( ) function. FIG. 9 depicts a template 804 and transformation 802 containing a tdt:split function (indicated at 808). Application of transformation 802 results in result 810.

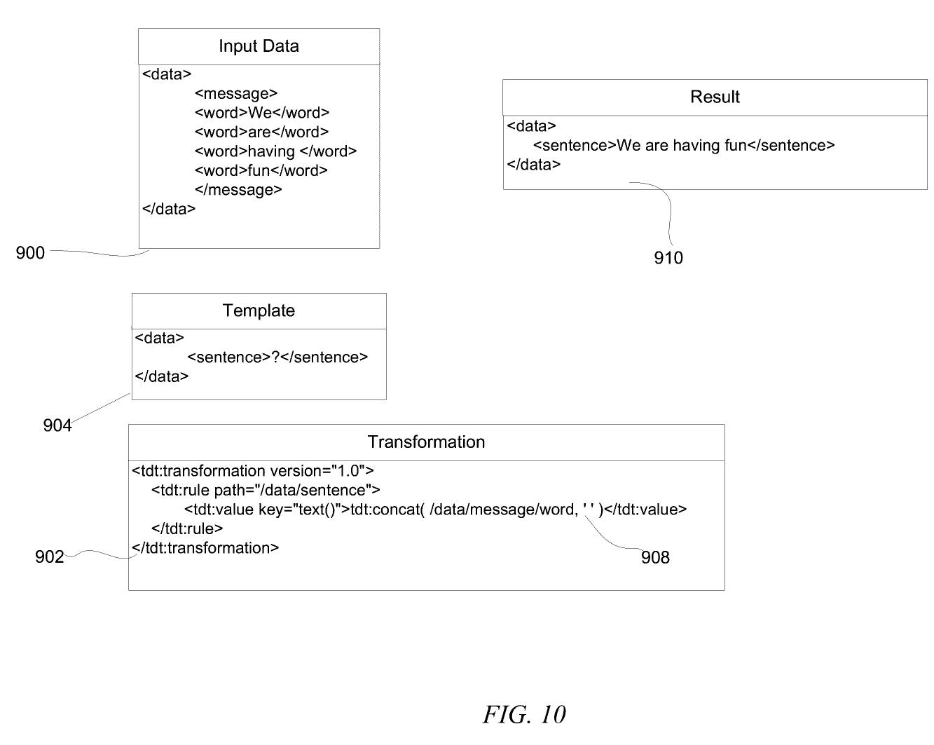

The tdt:concat( ) function takes a node set and a string separator and returns the concatenation of string values of the nodes in that node set. If the node set is empty, the function returns an empty string. If the separator is an empty string, then strings are concatenated without a separator. FIG. 10 illustrates one embodiment of the operation of the tdt:concat( ) function. FIG. 10 depicts input data 900, template 904 and transformation 902 containing a tdt:concat( ) function (indicated at 908). FIG. 10 further depicts example results 910 from transforming input data 900 according template 904 and transformation 902.

<node-set>tdt:group(<node-set>[, <string>, . . . ])+<node-set>tdt:ungroup(<node>) function causes transformation engine 135 to group given nodes based on given grouping criteria (aggregation keys). According to one embodiment, the tdt:group( ) function generates a break or new group every time the value of an aggregation key changes. Grouping criteria are represented by one or more strings containing relative XPaths, optionally prefixed with ‘˜’ aggregation prefix. When this function is called, several steps are performed. An input node-set is enumerated. All given XPaths are evaluated in context of each element. Aggregation is performed based on given aggregation keys. Grouping is performed based on equality. For each resulting group, a synthesized tdt:group element is created. A node-set of all synthesized “group” elements is returned.

Each synthesized tdt:group element contains summary information about the grouping operation, number of grouped nodes etc. but does not contain actual grouped nodes. The synthesized group nodes have the following structure:

<tdt:group size=″?″ id=″?″>
<tdt:key key=″?″>?</tdtkey>
</tdt:group>

In this structure, @size represents number of nodes in the group, @id is an internal identifier for the group. For tdt:key there one child for every grouping argument. @key is a string xpath used for grouping (optionally prefixed with ‘˜’ aggregation prefix). The <key> text node is the actual result data value of the xpath (used for grouping).

Access to grouped nodes is possible via the tdt:ungroup( ) function. This function accepts the synthetic group node as an argument and returns a Node-Set of grouped original nodes.

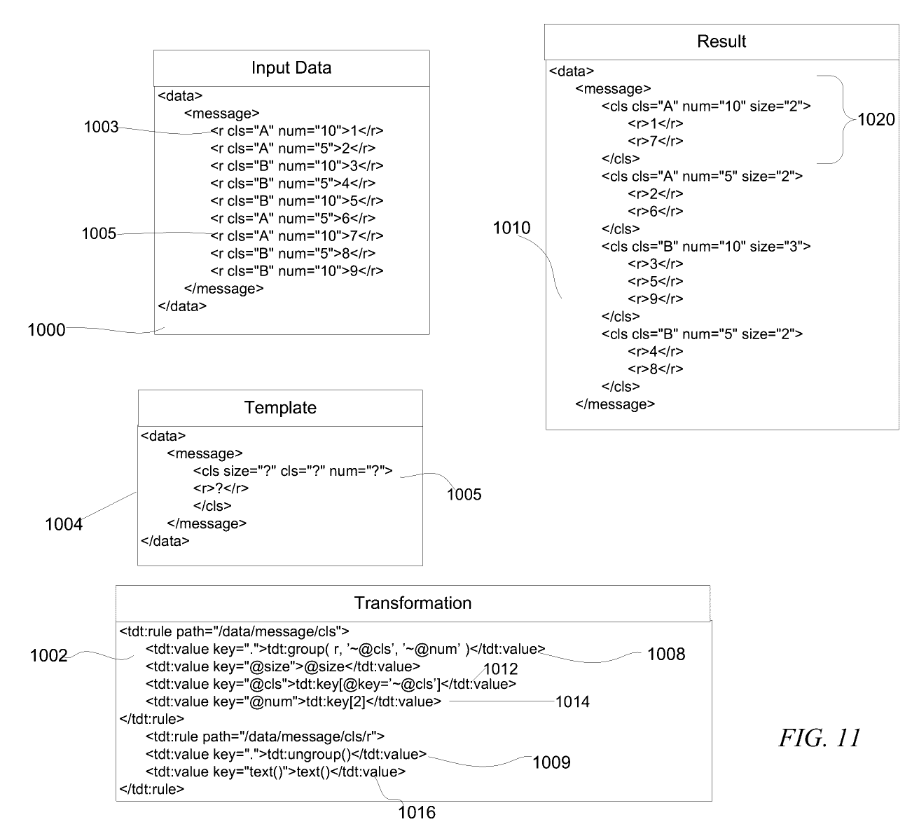

FIG. 11 illustrates one embodiment of using the tdt:group( ) and tdt:ungroup( ) functions. FIG. 11 depicts example input data 1000, template 1004, transformation 1002 and result 1010. Transformation 1002 includes tdt:group( ) and tdt:ungroup( ) function (indicated at 1008 and 1009). The tdt:group( ) function, in this example, operates on the elements<r> to group them by values of ‘cls’ and ‘num’ attributes.

The resulting node-set of this function has four synthetic group node members. The first synthetic tdt:group node in the example results 1010 is:

```
<tdt:group size=″2″ id=″1″>
  <tdt:key key=″~@cls″>A</tdt:key>
  <tdt:key key=″~@num″>10</tdtkey>
</tdt:group>
```

In this example, the evaluation context for the rule associated with <cls> element 1005 is set based on tdt:group(r, ‘˜@cls’, ‘˜@num’) . Accordingly, during execution <cls> element 1005 will be copied four times in the data instance of template 1004 (because there are four synthetic group nodes). The parameter values held by the <cls> elements can be retrieved from the synthetic group nodes using the XPaths in commands 1012 and 1014.

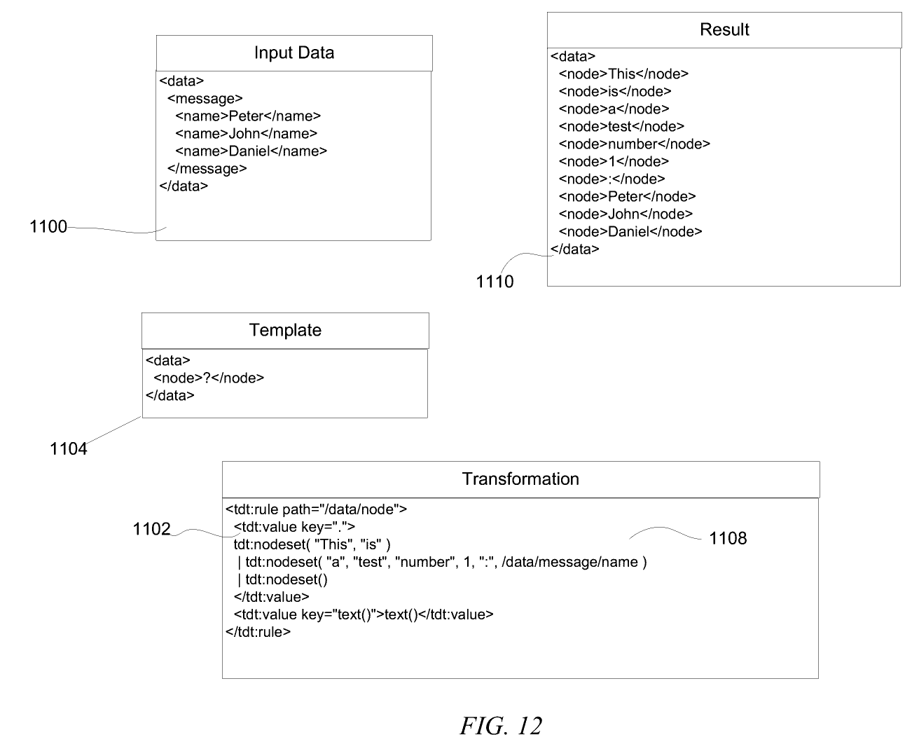

The data in the text nodes of the <r> elements is populated by ungrouping the appropriate synthetic group node. For example, for the first copy of the <cls> element 1005, data transformation engine 135 can ungroup the first synthetic group node creating a result node set with two members, node 1003 and node 1005. In this <cls> element (indicated at 1020 in result 1010), two copies of the <r> element are made based on the result node set of command 1009. The text node of each of these <r> elements can be populated based on the XPath in command 1016 for the corresponding node in the result node set.

<node-set>tdt:nodeset([ <object>, . . . ]) accepts any number of arguments (0, 1 or more) of any type (node-set, node, string, number) and creates a single node-set as a result. If an argument is a node-set, then all the nodes it contains will appear flattened in the resulting node-set. FIG. 12 illustrates one embodiment of using a tdt:nodeset( ) function. FIG. 12 depicts example input data 1100, template 1104 and transformation 1102 including a tdt:nodeset( ) function (indicated at 1108). This function will create a set with the following nodes: This, is, a, test, number, 1, :, Peter, John, Daniel. Since this nodeset is evaluation node set as specified by 1108, ten copies of the <node> element 1105 will be created and populated accordingly.

FIG. 12 further depicts the example results 1110 of transforming input data 1100 according to template 1104 and transformation 1102.

In one embodiment, transformation engine 135 can support a tdt:template( ) function that provides access to the data template corresponding to a transformation. This function can be used, for example, to create a static lookup table in the template.

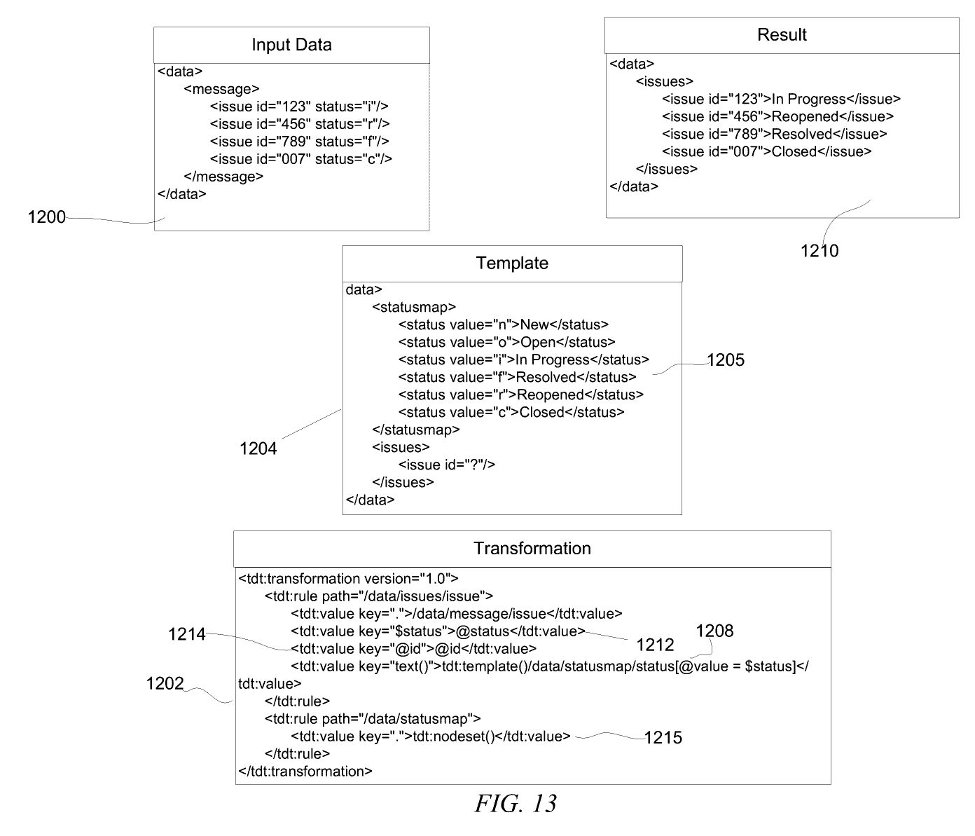

FIG. 13 illustrates an embodiment of using a tdt:template( ) function to provide a lookup table.

FIG. 13 depicts example input data 1200, template 1204 having lookup table 1205 and transformation 1202 including a tdt:template( ) function (indicated at 1208) that allows the transformation rule access to lookup table 1205. FIG. 13 further depicts the example results 1210 of transforming input data 1200 according to template 1204 and transformation 1202. In this example, command 1212 sets the variable $status equal to the status attribute's value for the input <issue> element being evaluated, command 1214 sets the value of the id attribute of the current template <issue> element to be equal to the value of the id attribute of the input <issue> element and command 1208 sets the text node of the current template <issue> element by using the variable $status to lookup a status in lookup table 1205.

In some embodiments, a template node is copied to the data instance of the template if no rule is defined for the node. Under this scheme <statusmap> may be copied if no rule is defined for <statusmap>. To account for this, transformation 1202 can include rule 1215. Since, however, the evaluation result node set of rule 1215 is empty, <statusmap> is not copied into the result. Rule 1215 effectively removes the <statusmap> element (with all its children) as the lookup table is not need in the resulting data instance.

In addition to supporting custom XPath functions, transformation engine 135 may also support special forms of processing. Special forms may be used for sorting and carrying out other operations. One example of a special form is “union.” The above examples can be considered “design driven” because it is the expected output structure that drives the order in which data appears in the output. On the other hand, in some cases the user may want to preserve the data in the order in which it was received. That is, the user may wish to take a “data driven” approach in which the data order in the input drives the order in which data appears in the output. The union form addresses the situation in which input data may be in an arbitrary order and the user wants to preserve the order for presentation.

For the elements that the user wishes to preserve data order, a union command can be included in the rule corresponding to that element. The union specification XPath expression must be identical for all elements for which the data order is being maintained and a variable definition is a suitable tool for simplification. All subsequent elements with identical union XPath expressions are treated as a single union. That means that the union string is evaluated once and then a secondary Xpath selector is evaluated for each individual element. This way the original ordering of elements is preserved.

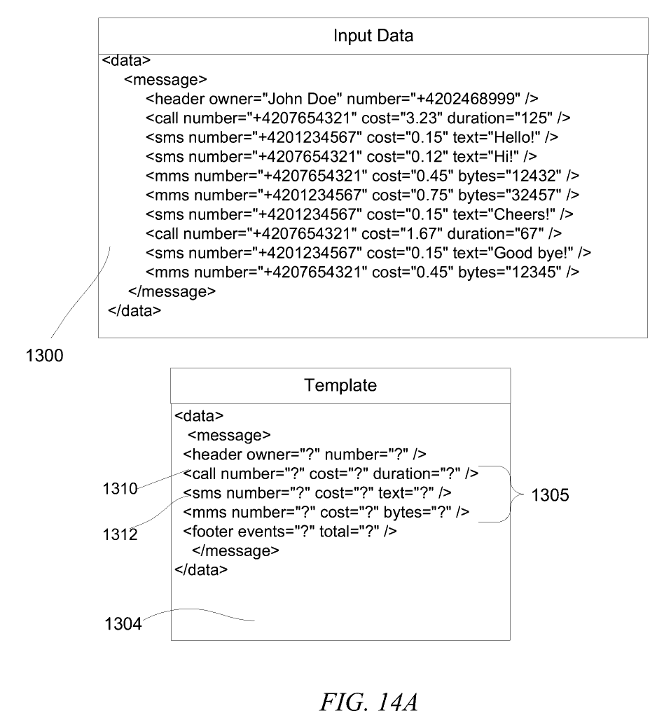

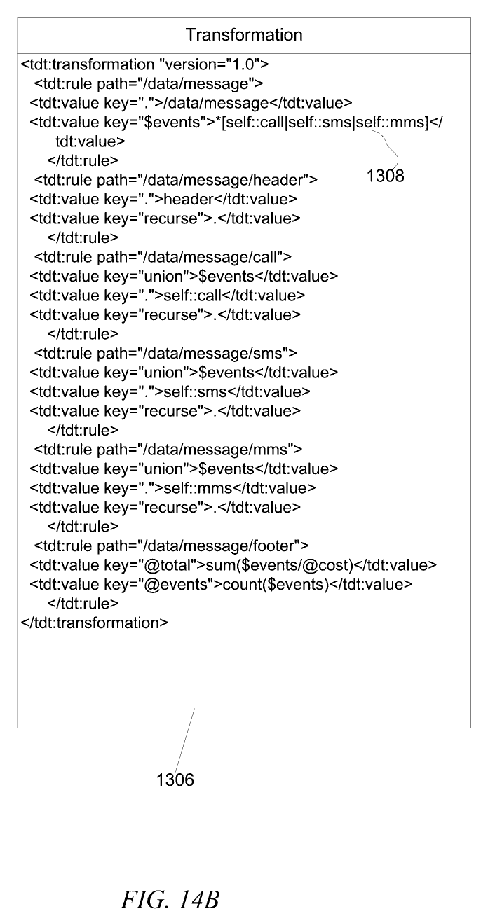

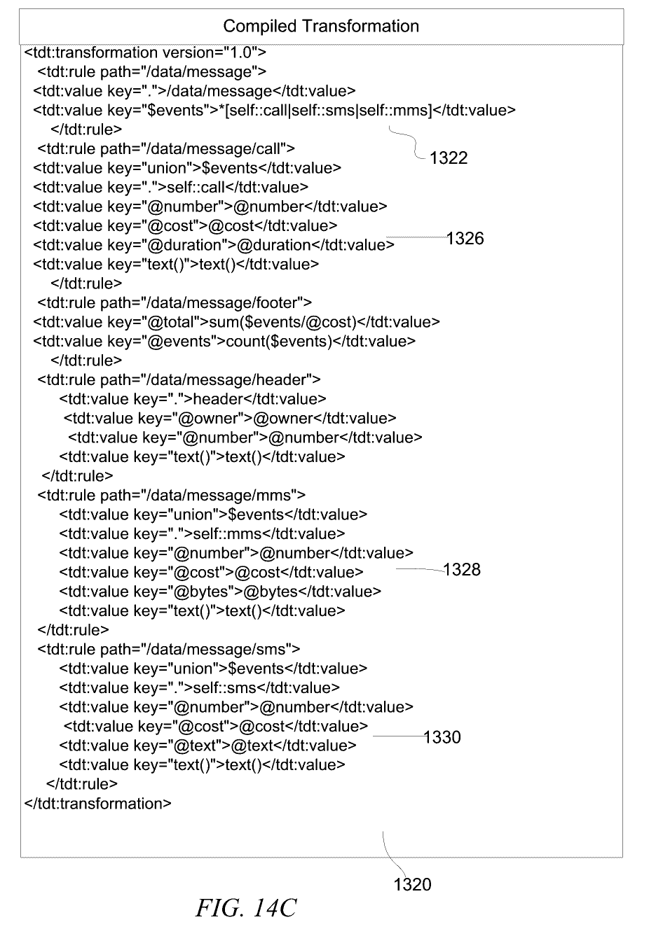

FIG. 14A, for example, illustrates a set of input data 1300 for which the user wishes to preserve the order, a data template 1304 and a data transformation 1306. The elements for which the input order is to be preserved are defined together in template 1304 (indicated at 1305). FIG. 13B illustrates an example compiled transformation 1320. The result (not shown) will be identical to input data 1300 except for the addition of a footer specified by data template 1304.

Data transformation 1320 includes the expression <tdt:value key=“$events”>*[self::call|self::sms|self::mms]</tdt:value> (indicated at 1322). During execution, this Xpath retrieves all <call>, <sms>and <mms> elements from input data 1300 in data order and stores the result in the variable $event. For each template element for which the input order is to be preserved, the corresponding transformation rule includes a union command referencing the same XPath expression (e.g., each of rule 1326, 1328 and 1330 includes a union command referencing variable $events).

During execution, transformation engine 135 will process “$events”>*[self::call|self::sms|self::mms]</tdt:value> when it performs variable evaluation for the <message> element of data template 1305, thereby setting variable $events. Transformation engine 135 can continue traversing element tree as discussed above, processing each element. When transformation engine 135 reaches the first rule containing the union XPath expression (representing primary selection), it can determine the other rules that contain the same union. Transformation engine 135 can then process the nodes in the union string in data order, creating a copy of the appropriate template node based on the rules that contain the union string. In the example of FIG. 14, when the transformation engine 135 evaluates the first node in the union string, which will be a <call> element, transformation engine 135 can determine that rule 1326 applies (e.g., based on <tdt:value key=“.”>self::call</tdt:value>) and populate a copy of <call> element 1310 in the data instance of template 1304. However, when transformation engine 135 processes the second node from the union, which will be an <sms> element, transformation engine 135 can determine that rule 1330 applies (e.g., based on <tdt:value key=“.”>self::sms</tdt:value>) and populate a copy of <sms> element 1312 in the data instance of template 1304. This process can continue until all the nodes in the union string have been processed. Transformation engine 135 can then process other elements as it normally would.

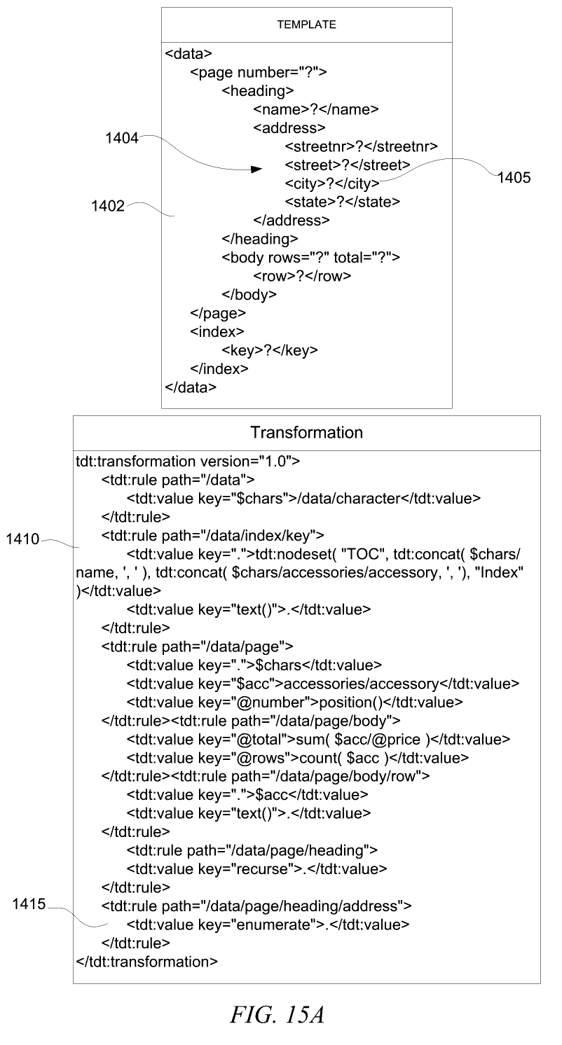

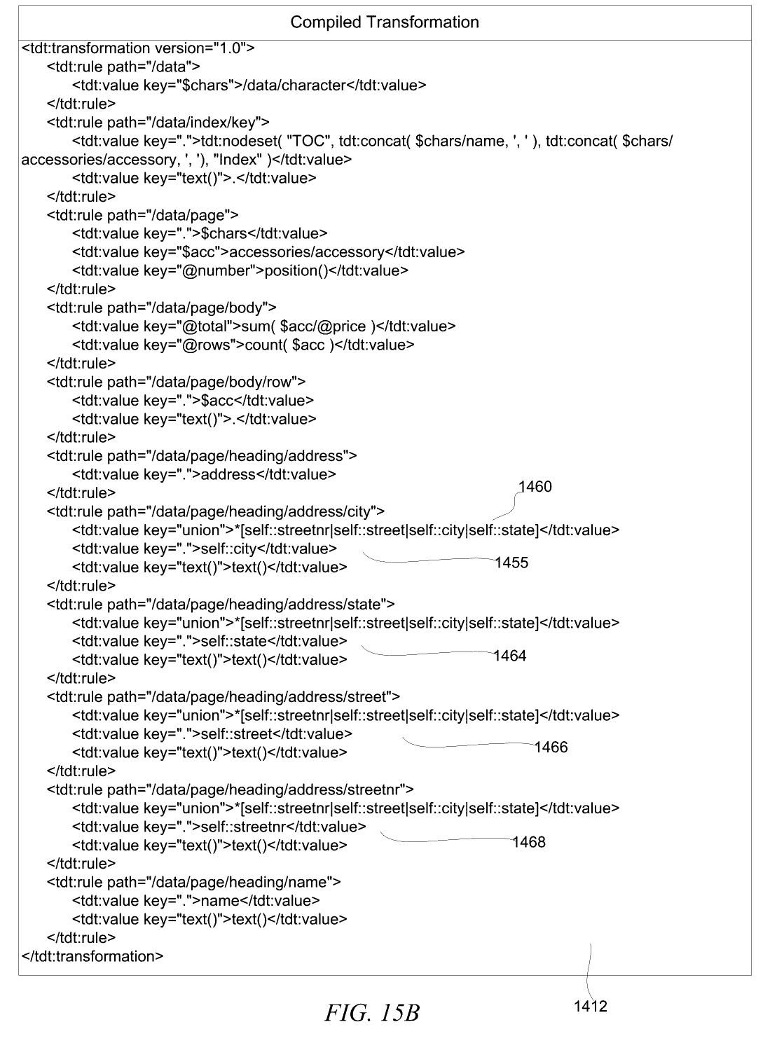

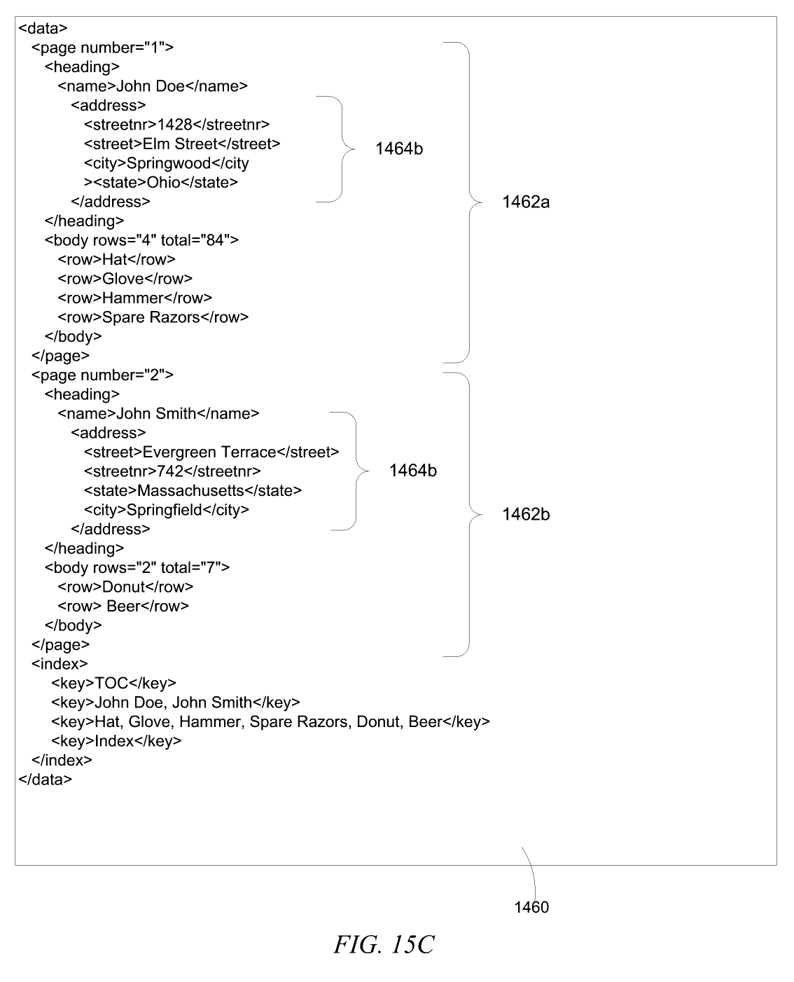

An enumerate meta-rule can leverage the union form. Enumerate is similar to recurse except that enumerate maintains the element order from the input data. FIG. 15A, FIG. 15B and FIG. 15C (collectively FIG. 15) illustrate one embodiment of a template 1402, a transformation 1410, a compiled transformation 1450 and a result 1460. In this example transformation 1410 includes an enumerate rule 1415. Template 1402 and transformation 1410 are configured to transform input data 200 of FIG. 4. In this input data, the address for character “John Doe” lists streetnr before street while the address for character “John Smith” lists street before streetnr. Enumerate rule 1415 of FIG. 15A can preserve this data order.

During the compilation phase, transformation engine 135 can access data template 1402 and data transformation 1410 and traverse template 1402, checking for each element whether a rule has been defined in data transformation 1410 for that element. In this example, data transformation engine 135 will eventually reach <address> element 1404 and determine that a rule 1415 with an enumerate expression has been defined for it.

In processing the enumerate expression, transformation engine 135 can identify the elements to which enumeration will apply, in this case the children of the <address>node and can select one of the elements based on selection rules. For example, transformation engine 135 can select an element at a particular level in a tree in alphabetical order. In this example, transformation engine 135 can select the <city> element 1405 over its siblings. Transformation engine 135 can generate a transformation rule 1455 for <city> element 1405 with one or more default expressions. In the embodiment illustrated, transformation engine 135 generates rule 1455 with expression 1460 that is a union of the sibling elements of the subtree being enumerated (e.g., <streetnr>, <street>, <city>, <state>). Like recurse, enumerate assumes the structure of the subtree at which the enumerate is specified matches the input data structure. Similar union commands are generated for the sibling nodes and inserted in rules 1464, 1466 and 1468 of compiled transformation 1412. During the execution phase, the union retrieves all the <city><streetnr>, <street>, <city>, <state> elements from the appropriate node in the input data 200 in data order (again maintaining the data context between a copy of a template element in the data instance and a corresponding node from the input data (e.g., <page>element 1462a corresponds to <character> element 230a and page element 1462b corresponds to <character> element 230b). The union can be processed as discussed above, and the order of data in <address> element 1464a will be different than that in <address>element 1464b due to the different orders in input data 200. If a recurse had been used instead, the orders of data in <address> element 1464a and <address> element 1464b would have been the same, absent additional post transformation processing.

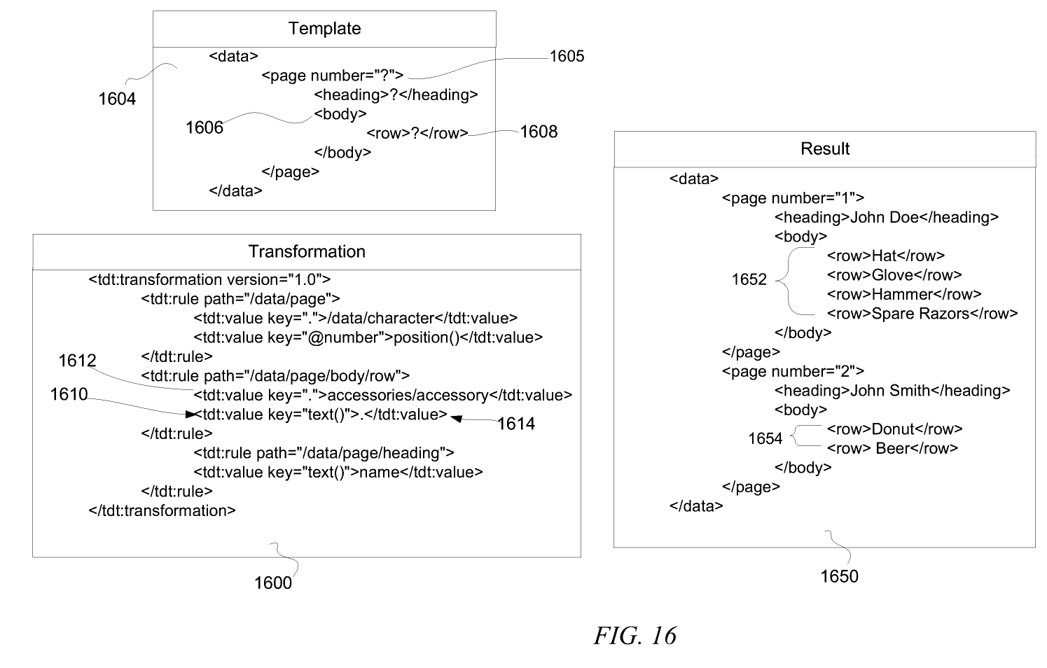

With reference to FIG. 16, another example of a data transformation 1600, data template 1604 and result 1650 are illustrated. Data template 1604 and data transformation 1600 are configured to transform the input data 200 of FIG. 4 and implement nested repeating. Because transformation engine 135 can maintain the data context hierarchically as the data template hierarchy is traversed, nested data repeaters can be easily implemented.

In the example of FIG. 16 the user wishes to present a dynamic body listing all the accessories of the particular character on the character's page. In this example, data template 1604 is similar to data template 202, but has added additional <body>and <row> elements 1606, 1608. Transformation 1600 is similar to transformation 220 but has added rule 1610 that refers to data template <row> element 1608. As with FIG. 4, there will be a copy of template <page> element 1605 for each <character> element in input data 200 and within each copy there will be a copy of <row> element 1608.

Rule 1610 specifies that the evaluation scope of rule 1610 is each accessories/accessory and will therefore include in the copy of the <page> element for a character a row <row> element for each <accessory> element in the corresponding <character> element. As the first character <element>1630a has four <accessory> elements and the second character <element>1630b only has two, the first <page> element will have four <row> elements 1652, and the second <page> element will only have two <row> elements 1654.

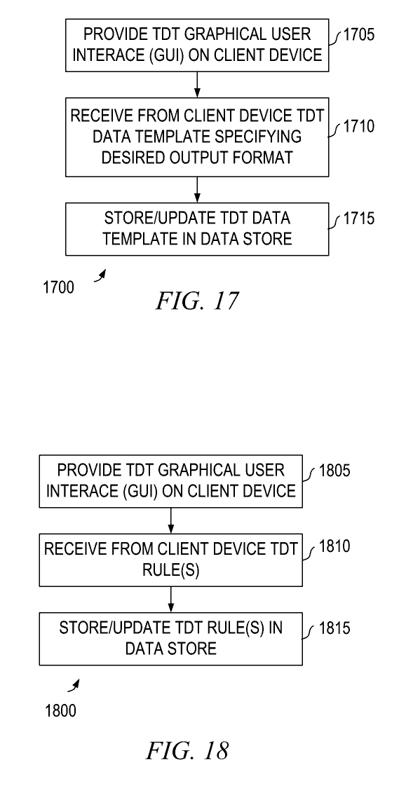

FIG. 17 is a flow chart illustrating process 1700 that may be implemented by TDT system 140 of FIG. 1. A user of a TDT system 140 may access a TDT user interface (e.g., TDT user interface 113 running on client device 103 or TDT user interface 115 running on client device shown in FIG. 1) provided by a TDT interface module of the TDT system (e.g., TDT interface module 125 shown in FIG. 1) to create and/or modify a data template (1705).

According to one embodiment, the TDT system can provide a data transformation editor through which a user can access a sample set of input data. For example, a user may access a message structure such as:
Message
   field1
   field2
   field3

The transformation editor can automatically create an initial structure by copying the structure of the sample input data, for example, creating an initial template:

```
<data>
  <message>
    <field1>SampleData</field1>
    <field2>SampleData</field2>
    <field3>SampleData</field3>
  </message>
</data>
```

The user can then be given options to create, edit and delete nodes in the template until the template matches the expected output structure. In another embodiment, the user can create a template manually. It can be noted, however, that while an example set of input data may be helpful in creating a template, the template does not depend on the input data structure. Instead, the template reflects the desired output structure. In fact, a user could create a data template with no knowledge of the input data structure. Knowledge of the input data structure is imbedded in the transformation rules, which can be defined independently of the data template.

Referring to FIG. 18, in a separate and independent process 1800, the same user or a completely different user may access a TDT user interface provided by the TDT interface module of the TDT system to create and/or modify a set of TDT rules (1805) (e.g., a transformation). As exemplified by various embodiments of transformation described herein, such transformation rules can be declarative, result-oriented, and devoid of format information for a desired result. The TDT system may receive the created and/or updated transformation rules via the TDT user interface (1810) and store/update (1815) the rules in a data store separately and independently of the TDT data templates (e.g., data store 150 shown in FIG. 1). For example, in one embodiment, a data template and its corresponding rules may be stored as independent XML documents (in the same data store or in different data stores).

As exemplified by various embodiments discussed above, a transformation rule may include a sequence of unified commands in a key-value form. This construct allows the user interface to be very user-friendly, particularly for non-programmers. A user can easily access a tree view of the TDT user interface and use a drag-and-drop functionality to create/edit a TDT data template, define/modify individual commands, etc.

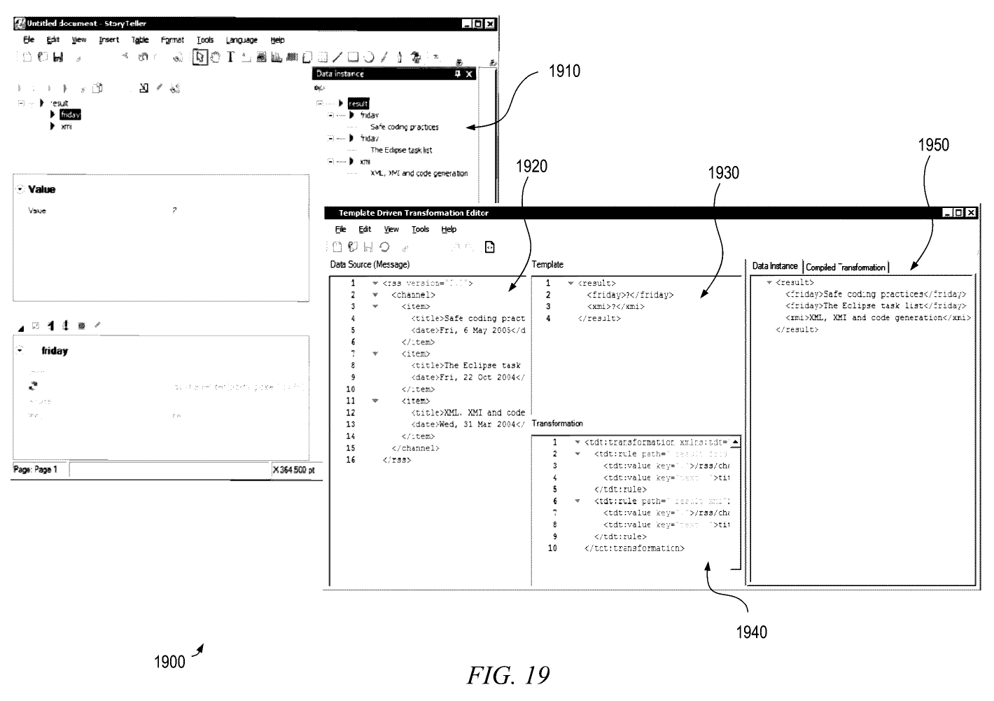

FIG. 19 depicts screenshots of an example of a user interface for viewing and editing templates and rules. User interface 1900 may include view 1910 configured for showing a tree view of source data, view 1920 configured for showing the source data, view 1930 configured for showing a data template being created/edited, view 1940 configured for showing transformation rules, and view 1950 configured for showing a data instance (e.g., output of the transformation process) generated by a TDT engine (e.g., transformation engine 135 shown in FIG. 1) using the applicable transformation rules.

In some embodiments, the user interface may be implemented as a Web-based interface that runs within a browser application, eliminating the need to install TDT client software. This implementation can be part of a design tool application provided to a user over a network.

One benefit provided by the TDT user interface is that a user can now easily select and edit the source data (e.g., via a source data view) and see the change being immediately processed by the transformation engine and presented (e.g., via a data instance view) on the user interface right away. The same ease of use also applies to modifying a transformation rule or data template.

The TDT system disclosed herein can have many uses including XML-to-XML transformation. Moreover, the system can transform other XML-like languages. For example, a data template may be created using a SVG editor and transformed by the transformation engine into a dynamic SVG (which is an example of a TDT result). As another example, a data template may be created using an XHTML editor and transformed by the transformation engine into a dynamic XHTML (which is another example of a TDT result).

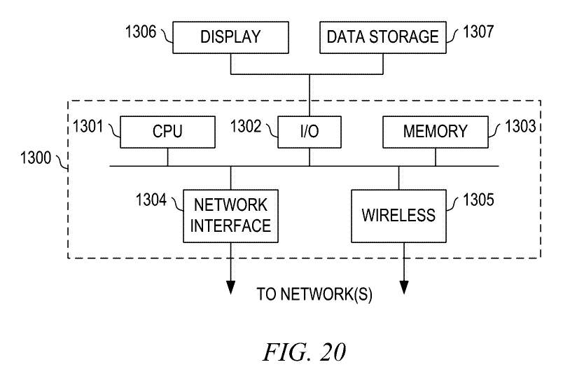

FIG. 20 depicts a diagrammatic representation of one example embodiment of a data processing system that can be used to implement embodiments disclosed herein. As shown in FIG. 20, data processing system 2000 may include one or more central processing units (CPU) or processors 2001 coupled to one or more user input/output (I/O) devices 2002 and memory devices 2003. Examples of I/O devices 2002 may include, but are not limited to, keyboards, displays, monitors, touch screens, printers, electronic pointing devices such as mice, trackballs, styluses, touch pads, or the like. Examples of memory devices 2003 may include, but are not limited to, hard drives (HDs), magnetic disk drives, optical disk drives, magnetic cassettes, tape drives, flash memory cards, random access memories (RAMs), read-only memories (ROMs), smart cards, etc. Data processing system 2000 can be coupled to display 2006, information device 2007 and various peripheral devices (not shown), such as printers, plotters, speakers, etc. through I/O devices 2002. Data processing system 2000 may also be coupled to external computers or other devices through network interface 2004, wireless transceiver 2005, or other means that is coupled to a network such as a local area network (LAN), wide area network (WAN), or the Internet, as described above.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer, or a special purpose computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

The functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed networked systems, components and circuits. In another example, communication or transfer (or otherwise moving from one place to another) of data may be wired, wireless, or by any other means.

A “computer-readable medium” may be any medium that can contain, store, the program for use by or in connection with the instruction execution system, apparatus, system or device. The computer readable medium can be, by way of example only but not by limitation, an electronic, magnetic, optical, electromagnetic, infrared, or semiconductor system, apparatus, system, device or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such product, process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of this disclosure should be determined by the following claims and their legal equivalents.

What is claimed is:

1. A template driven transformation system, comprising:
a data store storing a transformation data template comprising a hierarchy of nodes that represents an output data structure and independently storing a first transformation that comprises a set of rules for transforming input data into the output data structure specified by the transformation data template;
a processor;
a computer readable medium coupled to the processor storing a set of instructions executable by the processor to provide a data transformation engine operable to:
receive an input set of source data;
in a compilation phase, compile transformation rules from the first transformation into a compiled transformation, the transformation rules corresponding to elements in the transformation data template; and
in an execution phase, traverse the hierarchy in the transformation data template, evaluate each node in the hierarchy based on a corresponding transformation rule and populate the data structure with the source data in a data instance according to an instruction in the corresponding transformation rule to produce a document with data structured according to the output data structure.

2. The system of claim 1, wherein the hierarchy of nodes comprises a hierarchy of elements defined by markup language tags.

3. The system of claim 1, wherein the set of instructions are further executable to provide a graphical user interface for editing the transformation template to a computing device communicatively connected to a server machine over a network.

4. The system of claim 3, wherein, the transformation engine is responsive to a change to the source data, the transformation data template, or the corresponding transformation rule to dynamically perform the compiling and the transforming and present the data instance reflective of the change via the graphical user interface on the computing device.

5. The system of claim 1, wherein the corresponding transformation rule is defined in a key-value form using a declarative programming language, wherein the value is defined by an XPath.

6. The system of claim 1, wherein the transformation engine is operable to copy the transformation rules from the first transformation to the compiled transformation.

7. The system according to claim 1, wherein the transformation engine is operable to transform meta-rules in the first transformation into transformation rules for use by the transformation engine.

8. The system according to claim 1, wherein the transformation engine is operable to evaluate any variable declared in the corresponding transformation rule.

9. The system according to claim 1, wherein the transformation engine is operable to evaluate an XPath in the corresponding transformation rule to populate the data structure.

10. The system of claim 1, wherein the transformation engine is operable to:
evaluate a first XPath expression associated with a template element to determine an evaluation result node set from the input data;
for each node in the evaluation result node set, create a copy of the template element in the data instance, each copy corresponding to a different node in the evaluation result node set; and
for each copy of the template element, evaluate a second XPath in the rule to populate an attribute value or text node in the copy from the corresponding node of the input data.

11. A Template-Driven Transformation method, comprising:
receiving an input set of source data;
in a compilation phase, compiling, by a transformation engine, a compiled transformation of transformation rules, the transformation rules corresponding to elements in a transformation data template containing a hierarchy of markup language nodes that represents an output data structure;
in an execution phase, the transformation engine transforming the source data into a data instance of the transformation data template, the transforming including traversing the hierarchy in the transformation data template and evaluating each node in the hierarchy based on a corresponding transformation rule in the compiled transformation, the corresponding transformation rule including an instruction for populating the data structure with the source data in the data instance.

12. The method according to claim 11, wherein the transformation data template is created or modified independently of the corresponding transformation rule.

13. The method according to claim 11, wherein the transformation data template is created or modified via a graphical user interface on a computing device communicatively connected to the server machine over a network.

14. The method according to claim 13, wherein, responsive to a change to the source data, the transformation data template, or the corresponding transformation rule, the transformation engine dynamically performs the compiling and the transforming and presents the data instance reflective of the change via the graphical user interface on the computing device.

15. The method according to claim 11, wherein the corresponding transformation rule is defined in a key-value form using a declarative programming language.

16. The method according to claim 11, wherein in the compilation phase, user-defined rules are copied from a source location to a destination location.

17. The method according to claim 11, wherein in the compilation phase, meta-rules are transformed into transformation rules for use by the transformation engine.

18. The method according to claim 11, wherein the evaluating further comprises evaluating any variable declared in the corresponding transformation rule.

19. The method according to claim 11, wherein the evaluating further comprises evaluating an XPath in the corresponding transformation rule.

20. The method according to claim 11, wherein evaluating a node in the hierarchy based on the corresponding transformation rule further comprises:
evaluating a first XPath expression associated with a template element to determine an evaluation result node set from the input data;
for each node in the evaluation result node set, creating a copy of the template element in the data instance, each copy corresponding to a different node in the evaluation result node set; and
for each copy of the template element, evaluating a second XPath in the corresponding transformation rule to populate an attribute value or text node in the copy from the corresponding node of the input data.
